(19) United States
(12) Patent Application Publication
(10) Pub. No.: US 2025/0265413 A1
(43) Pub. Date: Aug. 21, 2025

(54) METHODS AND SYSTEMS FOR AUTOMATED CONTEXT MONITORING

(71) Applicant: Shopify Inc., Ottawa (CA)

(72) Inventors: Natalia Castillo Hernandez, Ottawa (CA); Jake Hendrick, Chelsea (CA); Bojan Antic, Ottawa (CA); Danielle Lynch, Ottawa (CA)

(73) Assignee: Shopify Inc., Ottawa (CA)

(21) Appl. No.: 18/444,462

(22) Filed: Feb. 16, 2024

(51) Int. Cl. G06F 40/284; G06F 9/451; G06F 40/174; G06F 40/205

(52) U.S. Cl. CPC G06F 40/284; G06F 9/451; G06F 40/174; G06F 40/205

(57) ABSTRACT

Disclosed herein are methods and systems for automated context monitoring. One method includes receiving customer input data from a client device and agent input data from an agent device during a chat session. The method can include, for a first state of the chat session, executing a large language model on the customer input data and the agent input data at the first state to generate a first summary; and updating an agent chat interface of the agent device based on the first summary. The method can also include, for a second state of the chat session, executing the large language model on the first summary and the customer input data and the agent input data at the second state to generate a second summary, and updating the agent chat interface based on the second summary.

### TECHNICAL FIELD

This application relates generally to automated context monitoring, and more particularly, to methods and systems of monitoring one or more electronic communications.

### BACKGROUND

Helpdesk agents often support end-user users through person-to-person chat interfaces. These agents typically conduct multiple support chats at the same time, which might lead an agent to make mistakes or lose conversation context as their attention shifts from one chat to another chat. The agents also have a limited amount of time to conduct meaningful research in order to answer one user's question, because performing in-depth research to answer a question in one support chat would delay the agent's interactions and responses in the other support chat. This delay is accentuated with increased simultaneous support chats.

This conventional process of having one individual manually conduct multiple chats can be inefficient and prone to human error. As a result, computational resources can be wasted maintaining communication between devices involved during the support chats as agents review and re-review conversations to reacquire the conversation context.

### BRIEF DESCRIPTION OF THE DRAWINGS

The accompanying drawings constitute a part of this specification and illustrate embodiments of the subject matter disclosed herein.

FIG. 1 shows components of a headless transaction system, according to an embodiment.

FIG. 2 shows execution steps for automated context monitoring, according to an embodiment.

FIG. 3A shows a block diagram of a simplified convolutional neural network which may be used in examples of the present disclosure.

FIG. 3B shows a block diagram of a simplified transformer neural network which may be used in examples of the present disclosure.

FIG. 4 shows a block diagram of an example computing system which may be used to implement examples of the present disclosure.

FIG. 5A shows example user interfaces which may be generated when implementing examples of the present disclosure.

FIG. 5B shows an example user interface which may be generated when implementing examples of the present disclosure.

FIGS. 6A-6F show an example user interfaces which may be generated when implementing examples of the present disclosure.

### DETAILED DESCRIPTION

Reference will now be made to the illustrative embodiments illustrated in the drawings, and specific language will be used here to describe the same. It will nevertheless be understood that no limitation of the scope of the claims or this disclosure is thereby intended. Alterations and further modifications of the inventive features illustrated herein, and additional applications of the principles of the subject matter illustrated herein, which would occur to one ordinarily skilled in the relevant art and having possession of this disclosure, are to be considered within the scope of the subject matter disclosed herein. The present disclosure is here described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

Current technological solutions do not include systems, tools, or platforms that automate context monitoring across multiple chat sessions. To address the above-described shortcomings, an automated context monitoring system may utilize server hosts chat interfaces to monitor chats during which customers communicate with agent-advisors (“agents”) for online support. The automated context monitoring system can generate a summary of the chat session as it progresses and execute a machine learning (ML) model (e.g., a large language model and/or the like) to perform various operations. For instance, the large language model can help identify the concepts discussed with the customer and prepare a summary for the agent's review, helping the agent prepare forms required to document the discussion and outcome of the first chat session. In addition, the automated context monitoring system enables each agent to conduct multiple simultaneous chat sessions with multiple customers by preparing summaries of the chat (or portions thereof) at a given state of each chat session based on some, or all, of the chat history, helping the agent switch between ongoing chats and quickly gather context when returning to a given chat interface. The automated context monitoring system may update the agent chat interface to display, for example, a transcript, the summary, the partial or updated summaries, and other types of information. A state of a chat session includes various types of data received, generated, retrieved, or otherwise obtained about the chat session for a discrete moment in time or snapshot in ongoing operations. Non-limiting examples of the state data includes inputs received from end-user devices (e.g., customer device and agent device), such as a chat inputs; metadata received or generated by the end-user devices or a host server; forms selected by an agent or automatically identified by the programming of the server; data retrieved from one or more databases by the server or end-user devices; and other types of data generated or retrieved to update a chat session summary, a form, a chat session window, or other aspects of the chat session.

In some cases, for example, the automated context monitoring system applies a large language model on a chat transcript based on a given time interval or triggering condition (“trigger”) to generate a first summary at a first state. At a later time or based on a trigger, the automated context monitoring system provides data associated with the first summary and the chat transcript to the large language model. The large language model then generates a second summary at a second state that is more contextually relevant, as the second summary is based on the ongoing chat transcript and the first summary, and thus reflects what has happened since the automated context monitoring system last executed the large language model on the chat transcript. The first state may include the various types of data received, generated, retrieved, or otherwise obtained by the server for the chat session at a first time or in response to a triggering condition. For example, at a preconfigured time interval or in response to a preconfigured triggering condition (e.g., a particular word or phrase occurring entered by the customer or agent; a particular graphical user interface selection entered by the customer or agent), the server hosting the chat session may automatically generate the first summary or predict a form to be filled, or execute various other potential operations. The second state may include the same or different types of data obtained for the chat session at a second time or in response to the same or different triggering condition. As an example, at the preconfigured time interval or in response to the same or different preconfigured triggering condition (e.g., a particular word or phrase occurring entered by the customer or agent; a particular graphical user interface selection entered by the customer or agent), the server hosting the chat session may automatically generate a second summary (e.g., update to the first summary; new summary for a separate portion of the chat session), update the form fields of the predicted form, predict a form to be filled, or execute various other potential operations. The temporal relationship between the first state and the second state (and any number of successive states of the chat session) may be a function of a preconfigured interval for generating the state. Additionally or alternatively, the temporal relationship between the first state and the second state (and any number of successive states of the chat session) may be arbitrary, as a function of when the server (or other devices) detect certain state data satisfying one or more triggering conditions.

By implementing the techniques described herein, the systems described determine what information exchanged during a chat session is relevant to the chat session and provide such relevant information via a graphical user interface (GUI). This, in turn, enables agents to respond with increasing timeliness and accuracy without the need to re-review the history at each state of a given chat session. And with the increase in timeliness and accuracy, chat sessions may be completed more quickly, thereby reducing the computational resources needed to maintain the chat sessions. For example, fewer unnecessary messages may need to be exchanged as the agent queries, and re-queries the customer to resolve an issue involving the customer, thereby resulting in reduced data transfer between the device associated with the customer and the device associated with the agent.

### Example Networked Components of System

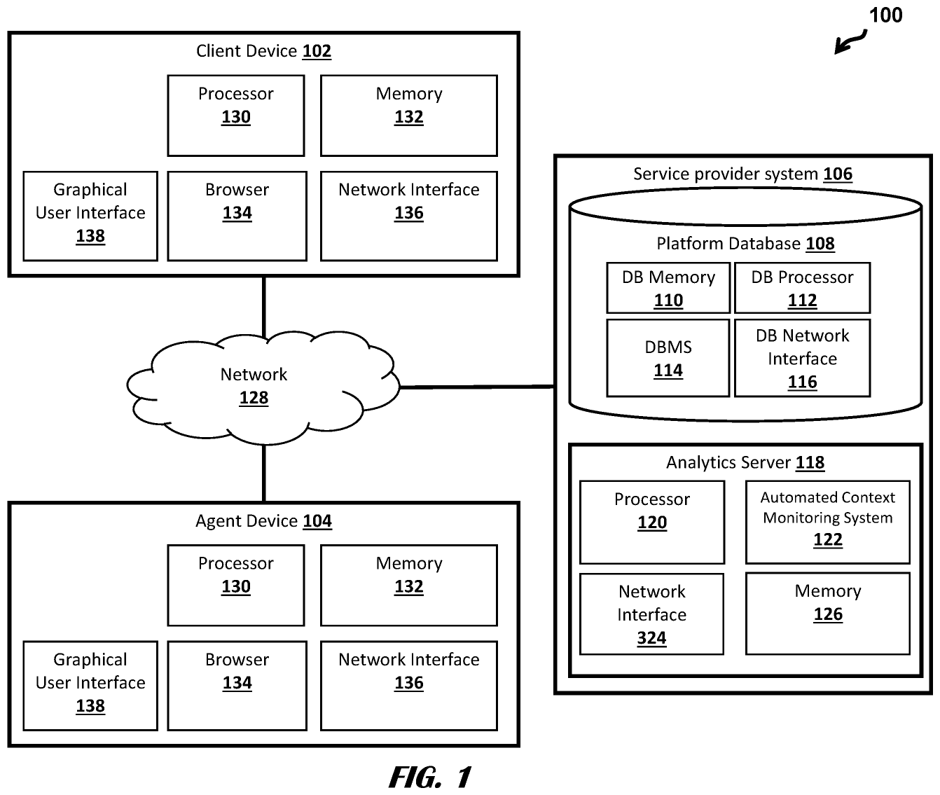

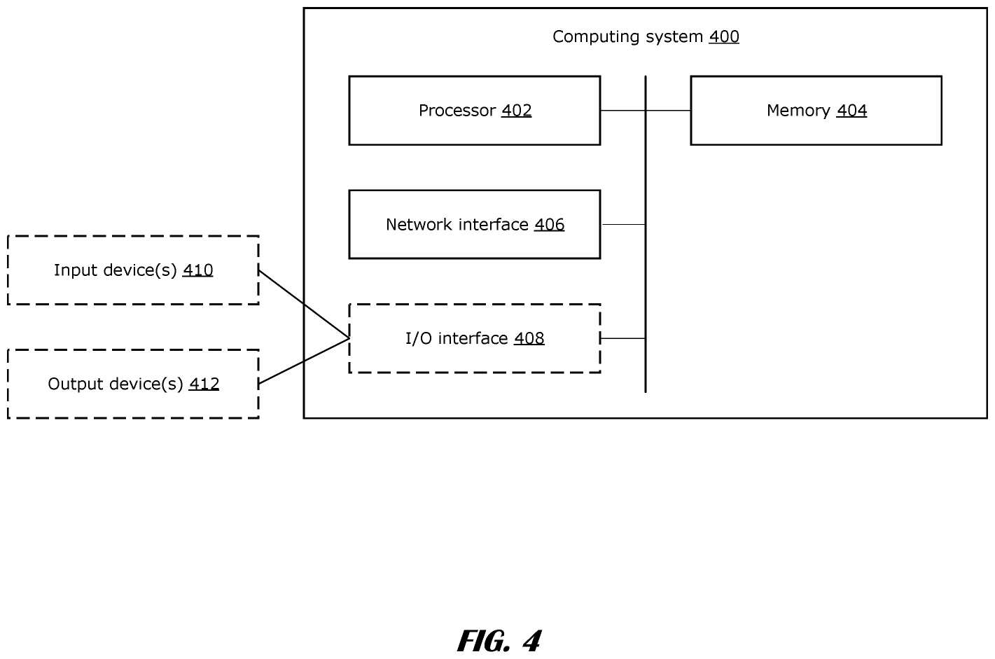

FIG. 1 illustrates components of a system 100, according to an embodiment. The system 100 may include a client device 102, an agent device 104, a service provider system 106, and a network 128. The depicted system 100 is described and shown in FIG. 1 as having one of each component for ease of description and understanding of the example. The embodiments may include any number of the components described herein. The embodiments may comprise additional or alternative components, or may omit certain components, and still fall within the scope of this disclosure. In some embodiments, the client device 102, the agent device 104, and/or the service provider system 106 may be the same as, or similar to (e.g., include one or more components of) the example computing system 400 of FIG. 4. It will be understood that components included in different systems illustrated by FIG. 1 that are referred to using the same or similar reference numbers (for case of reference) may be the same as, or similar to, one another when included in separate devices. For example, the processor 130 of client device 102 may be the same type of processor as the processor 130 of agent device 104.

In some implementations, the client device 102 is associated with an individual such as a user, a customer, a device owner, an account owner, an individual associated with a merchant, and/or the like that, in examples, is requesting assistance from an agent as described herein. In examples where the user is a customer, a device owner, an account owner and/or the like, the user may interact with the client device 102 by providing input that is then communicated to the agent device 104 so as to enable an agent to communicate with the user. In these examples, the agent may be an individual associated with a merchant that is assisting in the involved transaction. In other examples where the user is an individual associated with a merchant, the user (the individual associated with the merchant) may interact with the client device 102 by providing input that is then communicated to the agent device 104 so as to enable the agent to assist the merchant (e.g., when configuring an account associated with the merchant). In these examples where the user is a merchant, the agent may be an individual associated with a service provider system (e.g., an e-commerce platform that provides web-based services to enable merchants to execute transactions online). In some implementations, the agent device 104 is associated with an individual associated with an organization that supports one or more features and/or one or more products associated with the client.

The network 128 may include any number of networks, which may be public or private networks. The network 128 may comprise hardware and software components implementing various network and/or telecommunications protocols facilitating communications between various devices, which may include devices of the system 100 or any number of additional or alternative devices not shown in FIG. 1. The network 128 may be implemented as a cellular network, a Wi-Fi network (or other wired or wireless local area network (LAN)), a WiMAX network (or other wired or wireless wide area network (WAN)), and the like.

The client device 102 and the agent device 104 may be any computing system comprising hardware and software components capable of performing the various tasks and processes described herein. Non-limiting examples of the client device 102 and the agent device 104 may include mobile phones, tablets, smart watches, display devices that use augmented reality (AR) or virtual reality (VR) technology, laptops, and personal computers, among others. It will be understood that in some embodiments, the client device 102 and the agent device 104 may be the same type of device and, as such, similarly numbered features are described with respect to the same reference numeral for each device.

When communicating with components of the service provider system 106, the client device 102 and the agent device 104 may generate and transmit data (e.g., customer input data and agent input data respectively, described with respect to FIG. 4) that is processed by or otherwise accessible to the analytics server 118 of the service provider system 106. The web traffic may comprise data packets that include various types of data that can be parsed, analyzed, or otherwise reviewed by various programmatic algorithms of the analytics server 118. For instance, the web traffic data may indicate which website was accessed by a user operating the client device 102 or the agent device 104 (e.g., whether a user operating the client device 102 or the agent device 104 has accessed the website or whether the user has interacted with a graphical component of the website such as a component corresponding to a chat session).

The client device 102 and the agent device 104 may each include a processor 130, memory 132, GUI 138, and network interface 136. An example of the GUI 138 is a display screen (which may be a touchscreen), a gesture recognition system, a keyboard, a stylus, and/or a mouse. The network interface 136 is provided for communicating over the network 128. The structure of the network interface 136 will depend on how the client device 102 and the agent device 104 interfaces with the network 128. For example, if the client device 102 or the agent device 104 is a mobile phone or tablet, the network interface 136 may include a transmitter/receiver with an antenna to send and receive wireless transmissions to/from the network 128.

The client device 102 and the agent device 104 may be connected to the network 128 with a network cable. The network interface 136 may include, for example, a network interface card (NIC), a computer port, and/or a network socket. The processor 130 directly performs or instructs all of the operations performed by the client device 102. Non-limiting examples of these operations include processing customer inputs received from the GUI 138, preparing information for transmission over the network 128, processing data received over the network 128, and instructing a display screen to display information. The processor 130 may be implemented by one or more processors that execute instructions stored in the memory 132. Alternatively, some or all of the processor 130 may be implemented using dedicated circuitry, such as an ASIC, a GPU, or a programmed FPGA.

The service provider system 106 may be a computing system infrastructure that is associated with (e.g., owned, managed, and/or hosted) by an e-commerce service, though this need not be the case. The service provider system 106 includes electronic hardware and software components capable of performing various processes, tasks, and functions of the service provider system 106. For instance, the computing infrastructure of the service provider system 106 may comprise one or more platform networks (not explicitly shown) interconnecting the components of the service provider system 106. The platform networks may comprise one or more public and/or private networks and include any number of hardware and/or software components capable of hosting and managing the networked communication among devices of the service provider system 106.

The components of the service provider system 106 include the analytics server 118 and a platform database 108. However, the embodiments may include additional or alternative components capable of performing the operations described herein. In some implementations, certain components of the service provider system 106 may be embodied in separate computing devices that are interconnected via one or more public and/or private internal networks (e.g., network 128). In some implementations, certain components of the service provider system 106 may be integrated into a single device. For instance, the analytics server 118 may host the platform database 108.

The analytics server 118 may be any computing device that comprises a database processor 120 with non-transitory machine-readable storage media (e.g., memory 126) and that is capable of executing the software for one or more functions such as the automated context monitoring system 122. In some cases, the server memory 126 may store or otherwise contain the computer-executable software instructions, such as instructions needed to execute the automated context monitoring system 122. The software and hardware components of the analytics server 118 enable it to perform various operations that serve particular functions of the service provider system 106. In some embodiments, the analytics server 118 may be configured to serve various functions of the service provider system 106. Non-limiting examples of such functions may include webservers hosting webpages (or at least a portion of a webpage, such as the those used to facilitate communication between customers using a client device 102 and agents using an agent device 104) on behalf of merchants (e.g., merchants' online stores, merchants' helpdesks, and/or the like), among others.

The service provider system 106 is shown and described as having only one analytics server 118 performing each of the various functions of the e-commerce service. For instance, the analytics server 118 is described as serving the functions of executing automated context monitoring system 122. It is intended that FIG. 1 be merely illustrative and that embodiments are not limited to the description of the system 100 or the particular configuration shown in FIG. 1. The software and hardware of the analytics server 118 may be integrated into a single distinct physical device (e.g., a single analytics server 118) or may be distributed across multiple devices (e.g., multiple analytics servers 118).

The platform database 108 stores and manages data (e.g., data records) concerning various aspects of the service provider system 106, including information about, for example, customers and/or agents; the data may further include the data generated or captured during one or more chat sessions (e.g., customer input data and/or agent input data as described with respect to FIG. 4), ML models used to enable automated context monitoring, and other types of information related to the service provider system 106 (e.g., usage and/or services).

The platform database 108 may also include various libraries and data tables including detailed data needed to perform the methods described herein. For instance, the analytics server 118 may generate a data table associated with different form files used during automated context monitoring. In another example, the analytics server 118 may generate a data table associated with (e.g., including) data generated during a chat session involving the client device 102 and the agent device 104. The platform database 108 may also include a user profile that includes all data associated with a user account (e.g., user operating the client device 102). The user profile may include data associated with customer input data generated during earlier-conducted chat sessions and corresponding agent input data generated during the earlier-conducted chat sessions.

The platform database 108 may be hosted on any number of computing devices having a processor (sometimes referred to as a database (DB) processor 120) and non-transitory machine-readable memory configured to operate as a DB memory 110 and capable of performing the various processes and tasks described herein. For example, one or more analytics servers 118 may host some or all aspects of the platform database 108.

A computing device hosting the platform database 108 may include and execute database management system (DBMS) 114 software, though a DBMS 114 is not required in every potential embodiment. The platform database 108 can be a single, integrated database structure or may be distributed into any number of database structures that are configured for some particular types of data needed by the service provider system 106. For example, a first database could store data associated with one or more chat sessions involving one or more customers and/or one or more agents, a second database could store user credentials to later be accessed for authentication purposes, and a third database could store raw or compiled machine-readable software code (e.g., HTML, JavaScript) for webpages such that the DB memory 110 is configured to store information for hosting webpages.

The computing device hosting the platform database 108 may further include a DB network interface 124 for communicating via platform networks of the service provider system 106. The structure of the DB network interface 116 will depend on how the hardware of the platform database 108 interfaces with other components of the service provider system 106. For example, the platform database 108 may be connected to the platform network with a network cable. The DB network interface 124 may include, for example, a NIC, a computer port, and/or a network socket. The database processor 120 directly performs or instructs all of the operations performed by the platform database 108.

Non-limiting examples of such operations may include processing data communicated between (e.g., transmitted and/or received by) the client device 102, the agent device 104 and/or the analytics server 118, and preparing data for transmission via the platform network and/or the external networks. The database processor 120 may be implemented by one or more processors that execute instructions stored in the DB memory 110 or other non-transitory storage medium. Alternatively, some or all of the DB processor 112 may be implemented using dedicated circuitry such as an ASIC, a GPU, or a programmed FPGA.

The DB memory 110 of the platform database 108 may contain data records related to, for example, user activity, and various information and metrics derived from web traffic involving user accounts. The data may be accessible to the analytics server 118. The analytics server 118 may issue queries to the platform database 108 and data updates based upon, for example, earlier-conducted chat sessions.

With continued reference to FIG. 1, in an example, a user operating the client device 102 visits a website of a merchant (e.g., a merchant's online helpdesk) hosted by the service provider system 106 using the browser 134. The website of the merchant may include one or more features monitored by the analytics server 118. For instance, the analytics server 118 of the service provider system 106 may monitor communications enabled by the website of the merchant (e.g., communication via a component including a chat window included on the website of the merchant). The browser 134 may transmit and receive data (e.g., data packets and/or the like) in order to display various features (e.g., messages involved in communications between the client device 102 and the agent device 104 via the chat window) of the website of the merchant on a GUI 138.

In examples, a user operating the agent device 104 visits the website of a merchant (e.g., the merchant's online helpdesk) hosted by the service provider system 106 using the browser 134. The browser 134 may transmit and receive data (e.g., data packets and/or the like) in order to display various features (e.g., messages involved in communications between the agent device 104 and the client device 102 via the chat window) of the website of the merchant on a GUI 138.

The website of the merchant may refer to any electronic platform that is directly or indirectly hosted by a merchant. For instance, the website of the merchant may be a website displayed on a browser or a mobile application that is hosted (or otherwise functionally controlled) by the service provider system 106 and/or the analytics server 118). A user operating the client device 102 may execute the browser 134 (or other applications) to connect the client device 102 to the analytics server 118 and/or the agent device 104 using an IP address obtained by translating a domain name of the website. The analytics server 118 and/or the agent device 104 may execute code associated with the website and render the appropriate graphics to be presented to the GUI 138.

In some embodiments, the client device 102 and the agent device 104 may be in direct communication with the analytics server 118 for instance, via the browser 134 that is installed on the client device 102 and the agent device 104. The client device 102, the agent device 104, and/or the analytics server 118 may then execute the appropriate software programming or other machine-executed functions to enable communications between the client device 102 and the agent device 104 via the service provider system 106. For instance, using the browser 134 of the client device 102, a user operating the client device 102 may initiate a chat session (described in detail with respect to FIG. 4) and/or generate customer input data that is then transmitted by the client device 102 to the agent device 104 via the service provider system 106. In this instance, using the browser 134 of the agent device 104, a user operating the agent device 104 may participate in the chat session and/or generate agent input data that is then transmitted by the client device 102 to the agent device 104 via the service provider system 106. As a result, the analytics server 118 may monitor the user's (customer's) communications with the agent.

### Example Methods of Performing Automated Context Monitoring

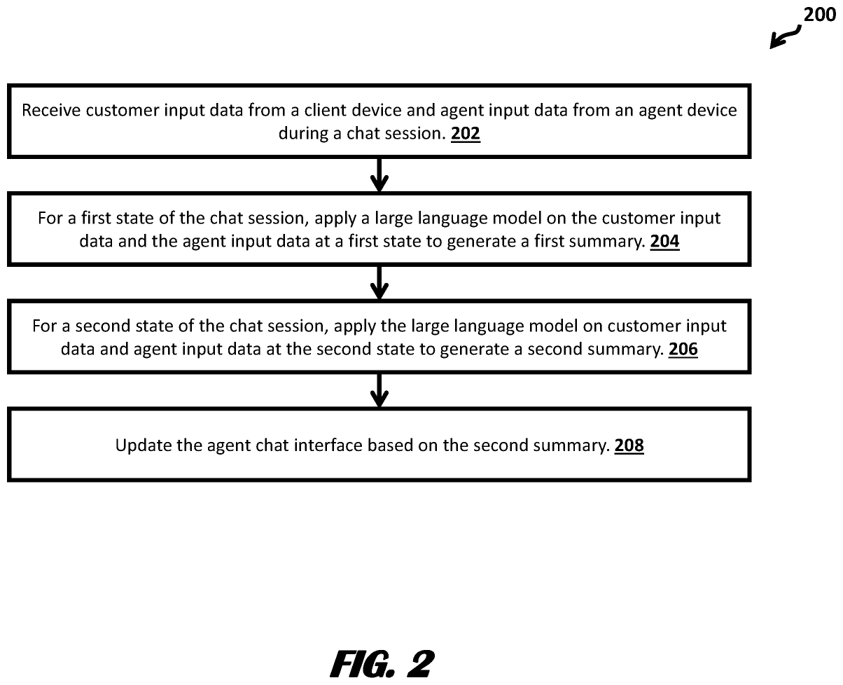

FIG. 2 illustrates a flowchart depicting operational steps for an automated context monitoring system, in accordance with an embodiment. The method 200 describes how an automated context monitoring system (e.g., various hardware and software computing components that is the same as, or similar to, the automated context monitoring system 122 that is implemented by the analytics server 118 described in FIG. 1) can monitor one or more electronic communications, which may include performing various analytics on the communications content or data by executing ML models on the electronic communications. Even though the method 200 is described as being executed by the automated context monitoring system, the method 200 can be executed by any server and/or locally (e.g., by a client device 102 and/or an agent device 104 that is the same as, or similar to, the client device 102 and the agent device 104 respectively in FIG. 1). Additionally, or alternatively, the method 200 may be implemented in other computer environments (e.g., other than the environments depicted in FIG. 1). Furthermore, other configurations of the method 200 may comprise additional or alternative steps or may omit one or more steps altogether. Without limiting the principles described herein, in an illustrative example, client devices described herein may be associated with customers (e.g., individuals) that are engaging with the client devices to provide input (e.g., questions and/or comments during a chat session); and agent devices described herein may be associated with agents (e.g., individuals that assist customers virtually) that are engaging with the agent device to provide input (e.g., responses) that are responsive to the customer's input.

At operation 202, customer input data is received from a client device and agent input data is received from an agent device during a chat session. For example, an automated context monitoring system may receive the customer input data based on a customer (e.g., an individual) providing input via a client device associated with the customer. The input may represent a string of text and/or other inputs provided via an input device associated with the client device. In this example, the client device may generate the customer input data based on the input from the customer at the client device and the client device may provide (e.g., transmit) the customer input data to the automated context monitoring system.

In some implementations, the client device is associated with an individual such as a user, a customer, a device owner, an account owner, an individual associated with a merchant, and/or the like that, in examples, is requesting assistance from an agent. In examples where the user is a customer, a device owner, an account owner and/or the like, the user may interact with the client device by providing input that is then communicated to the agent device so as to enable an agent to communicate with the user. In these examples, the agent may be an individual associated with a merchant that is assisting in the involved transaction. In other examples where the user is an individual associated with a merchant, the user may interact with the client device by providing input that is then communicated to the agent device so as to enable the agent to assist the merchant. In these examples where the user is a merchant, the agent may be an individual associated with a service provider system. In some implementations, the agent device is associated with an individual associated with an organization that supports one or more features and/or one or more products associated with the client.

In some embodiments, the client device generates the customer input data to initiate a chat session. For example, in the case where a customer requires assistance (e.g., in connection with a purchase they made, a product or service they purchased, and/or the like), the customer may navigate to a website using the client device to initiate the chat session. At this time, the customer may provide input via the input device associated with the client device, the input representing, for example, customer identifiers, transaction identifiers, product identifiers (e.g., a serial number), service identifiers (e.g., an order confirmation number), and/or the like. The customer may also provide input associated with one or more requests for assistance. For example, where a customer is unable to activate a product, the customer may provide input indicating that the customer is unable to activate the product. One example input can include a string of text “I cannot activate my new device.”

In some embodiments, when the customer engages with the automated context monitoring system via the client device, the automated context monitoring system may determine that a chat session has started or is ongoing. For example, the automated context monitoring system may determine that the customer input data is associated with a first message based on the automated context monitoring system determining that the client device was not recently involved in communications with the automated context monitoring system. In examples, the automated context monitoring system may determine that the customer input data is associated with one or more previously-received messages based on the automated context monitoring system determining that the client device was recently involved in communications with the automated context monitoring system, the communications associated with the previously-received messages. In these examples, the automated context monitoring system may associate an identifier with the customer input data and/or agent input data received during the chat session and associate the subsequently-received customer input data and/or agent input data received during the chat session based on the identifier.

In some embodiments, the automated context monitoring system is involved in a plurality of chat sessions that are ongoing independent of one another. For example, the automated context monitoring system may receive customer input data from a plurality of client devices. The plurality of client devices may be associated with (e.g., correspond to) distinct customers. In this example, the automated context monitoring system may associate the customer input data received from each device of the plurality of client devices and agent input data received from the agent device with their corresponding chat sessions. These may be stored by the automated context monitoring system as distinct chat sessions. In this way a one-to-many relationship may be established, whereby the agent device may communicate with the plurality of client devices separately during the plurality of chat sessions that are performed simultaneously.

At operation 204, for a first state of a chat session, an ML model (e.g., a large language model (LLM) and/or the like) is executed on the customer input data and the agent input data at a first state to generate a first summary. For example, the automated context monitoring system may execute an LLM on the customer input data and/or the agent input data generated during the first state (e.g., a first period of time during which the chat session is conducted) to generate the first summary. In such an example, the automated context monitoring system may execute the LLM on the customer input data and/or the agent input data based on the automated context monitoring system providing the customer input data and/or the agent input data to the LLM to cause the LLM to generate an output. The output may be data associated with the summary. In some embodiments, the output may be a single string of text. Additionally, or alternatively, the output may be represented as a form. The form may be based on a form file (e.g., a file based on a JSON schema and/or the like). While the present description is in reference to the use of LLMs, it will be understood that other suitable ML models may be used in addition to, or in place of, LLMs such as other transformer-based ML models and/or the like.

In some embodiments, where the customer input data is associated with at least one message (e.g., a distinct string or strings of text) and/or the agent input data is associated with at least one message, the automated context monitoring system may aggregate the messages and generate data to provide to the LLM when generating the first summary. For example, in the case where the customer input data is associated with one or more customer messages and/or the agent input data is associated with one or more agent messages, the automated context monitoring system may aggregate the customer messages and the agent messages and provide data associated with the aggregated messages to the LLM to cause the LLM to generate an output. In one illustrative example, where the customer messages and the agent messages represent strings of text provided by the customer or agent via the client device or agent device (respectively) during the chat session, the automated context monitoring system may combine (e.g., concatenate) the strings of text and generate the data to be provided to the LLM based on the combined stings of text.

In one illustrative and non-limiting example, the automated context monitoring system may monitor a chat session based on receiving customer input data and agent input data representing a series of messages exchanged between a customer and an agent as follows: Customer: “I need assistance with activating my device.” Agent: “What is your name, where did you buy it, and what is the serial number on the device?” Customer: “My name is John Doe. I purchased my laptop today at 10 AM ET and the serial number is 1234567890.” In this example, the automated context monitoring system may concatenate the individual strings into one string and provide data associated with (e.g., representing) the string to the LLM. The LLM may then generate an output including a form based on receiving the data associated with the string. The form may include a first field corresponding to the customer's name (e.g., “Name: John Doe”), a second field corresponding to the product's name (e.g., “Product: laptop”), and a third field corresponding to the product's identifier (e.g., “Serial No.: 1234567890”). It will be understood that this example is not intended to be limiting of the number of fields or information that can be collected and analyzed by the automated context monitoring system.

The automated context monitoring system may generate a transcript based on (e.g., representing) the chat session. For example, as illustrated above, the automated context monitoring system may receive customer input data and/or agent input data during a chat session. The automated monitoring system may then combine the strings of text associated with the customer input data and/or the agent input data in the order in which they were transmitted to generate a transcript. In some embodiments, the automated context monitoring system may then provide data associated with the transcript to the LLM to cause the LLM to generate a summary. Additionally, or alternatively, the automated context monitoring system may provide data associated with a portion of the transcript to the LLM to cause the LLM to generate the summary.

The automated context monitoring system may obtain a first feature embedding. For example, the automated context monitoring system may obtain the first feature embedding based on the first summary. In examples, the automated context monitoring system may tokenize each word in the summary to generate the first feature embedding. In some examples, the automated context monitoring system may generate a set of vectors based on each word in the summary to generate the first feature embedding.

The automated context monitoring system may select a form file based on the first feature embedding. For example, the automated context monitoring system may select the form file from among a plurality of form files. In this example, the plurality of form files may be stored in a database associated with (e.g., in communication with) the automated context monitoring system. And the form file may include one or more fields that correspond to a context associated with the chat session. In some embodiments, the automated context monitoring system may parse the plurality of form files to determine the set of fields corresponding to each form file. For example, the automated context monitoring system may parse the plurality of form files to determine the set of fields, where each field has a name and corresponds to a type of information exchanged during a chat session. In some embodiments, the automated context monitoring system may identify instances of field names that correspond to field names included in the summary. For example, the automated context monitoring system may identify the instances of filed names in a form file corresponding to fields in the summary and copy the information from the summary into the form file.

The automated context monitoring system may select the form file based on the automated context monitoring system performing an embedding search. For example, the automated context monitoring system may compare the first feature embedding to the form files (e.g., to feature embeddings associated with the form files) and determine an embedding similarity (e.g., a value indicating a degree to which the first feature embedding matches the feature embeddings associated with the form files). The automated context monitoring system may then select a form file from among the form files based on the comparison.

The automated context monitoring system generates an agent chat interface. For example, the automated context monitoring system may generate an agent chat interface based on the first summary. In some embodiments, the automated context monitoring system generates a graphical user interface (GUI) when generating the agent chat interface. For example, the automated context monitoring system may generate the first summary associated with the first state of the chat session and incorporate some or all of the content of the first summary into the GUI. In some embodiments, the automated context monitoring system may generate data associated with the GUI. For example, the automated context monitoring system may generate data associated with the GUI, the data configured to cause a display associated with the agent device to display the GUI on at least a portion of the display. In some embodiments, the automated context monitoring system may provide (e.g., transmit) the data associated with the GUI to the agent device to cause the display of the agent device to present the GUI.

For a given support form, the automated context monitoring system may query the transcript generated for the chat session using the LLM or, for example, a regular expression search, to identify matching terms. For matching information, the automated context monitoring system may populate the support form with any information identified in the transcript or the first summary that matches to an input field. For instance, the automated context monitoring system may dynamically update a prompt or instructions fed to the LLM based on the matching information obtained from the conversation.

The automated context monitoring system generates an agent chat interface based on a summary and a selected form file. For example, the automated context monitoring system may generate the agent chat interface by copying text included in the summary that corresponds to the fields in the form file. The automated context monitoring system may then generate an agent chat interface based on the updated form file, generate data associated with a GUI based on the agent chat interface, and provide data associated with the agent chat interface to cause the display of the agent device to present the GUI (similar to as described above). In this example, the automated context monitoring system may generate a GUI that represents at least a portion of the form file selected using the first summary.

The automated context monitoring system may parse the updated file form into its constituent input fields and compare those input fields against the information in the first summary or transcript to identify information that is not included in the updated file form. Once the information that is not included is identified, the automated context monitoring system may prompt the agent to request the information from the customer (e.g., by prompting the agent to discuss the information that is not included during the chat session with the customer). The automated context monitoring system may further identify missing fields and update the agent chat interface to indicate the information remains missing, and suggest the agent request the additional from the customer. The agent may then provide input that is received by the automated context monitoring system, the input associated with a prompt response (e.g., information provided by the agent after receiving the prompt). In some cases, the automated context monitoring system may update the prompt or instructions, and/or provide the prompt response to the LLM based on the input fields that are unfilled. The LLM may then generate one or more questions for display to the agent interface, suggesting the agent ask the customer those questions in order to complete the support form.

At operation 206, for a second state of the chat session, the LLM is executed on customer input data and agent input data to generate a second summary. For example, the automated context monitoring system may receive customer input data and agent input data during second state of the chat session. The customer input data and the agent input data may similarly be associated with input provided by the customer via the client device and the agent via the agent device (respectively) during the chat session (described above). In examples, the customer input data is associated with messages representing the input from the customer communicated during the second state, and the agent input data is associated with messages representing the input from the agent communicated during the second state. In some examples, the automated context monitoring system may receive the customer input data and the agent input data during the second state of the chat session where the customer input data and the agent input data are associated with a plurality of respective messages.

The second state of the chat session may be associated with a period of time that is distinct from a period of time that is associated with the first chat session. For example, the period of time that is associated with the first state of the chat session may include a period of time where the agent is actively providing input via the agent device during the chat session, and the period of time that is associated with the second state of the chat session may include a period of time starting from when the agent selected a different chat session (e.g., involving a different customer) to engage with. In this example, the period of time that is associated with the second state of the chat session may include a period of time where the agent selected to return to the chat session involving the customer. In some embodiments, the first and second chat sessions may be part of a continuous chat conversation (e.g., where the customer continuously engages with the agent, though the agent may be engaged with multiple customers). Additionally, or alternatively, the first and second chat session may be part of separate chat conversations (e.g., chat conversations occurring over multiple periods of time separated by minutes, hours, days, and/or the like).

For a second state of a chat session, the LLM may be executed based on the customer input data and the agent input data at the second state to generate a second summary. For example, the automated context monitoring system may execute an LLM based on the customer input data and/or the agent input data generated during the second state to generate the second summary. In such an example, the automated context monitoring system may execute the LLM based on the customer input data and/or the agent input data received during the second state (e.g., the messages received during the second state) based on the automated context monitoring system providing the customer input data and/or the agent input data to the LLM to cause the LLM to generate an output. The output may be data associated with the second summary. In some embodiments, the output may be a single string of text. Additionally, or alternatively, the output may be represented as a form.

Where the customer input data is associated with at least one message received during the second state and/or the agent input data is associated with at least one message received during the second state, the automated context monitoring system may aggregate the messages and generate data to provide to the LLM. For example, in the case where the customer input data is associated with one or more customer messages and/or the agent input data is associated with one or more agent messages received during the second state of the chat session, the automated context monitoring system may aggregate the customer messages and the agent messages and provide data associated with the aggregated messages to the LLM to cause the LLM to generate an output (similar to the description above with respect to the aggregation of customer input data and agent input data during the first state of the chat session). In one illustrative example, where the customer messages and the agent messages represent strings of text provided by the customer or agent via the client device or agent device (respectively) during the second state of the chat session, the automated context monitoring system may combine the strings of text and generate the data to be provided to the LLM based on the combined stings of text. The output generated may be associated with (e.g., represent) the second summary.

The automated context monitoring system may generate the second summary based data associated with a message buffer. For example, the automated context monitoring system may determine a plurality of messages associated with the customer input data and the agent input data where the plurality of messages correspond to input provided by the customer and agent during the first state of the chat session and/or the second state of the chat session. In this example, the automated context monitoring system may determine the plurality of messages based on a period of time in which the messages were received and/or a threshold number of messages that may be stored in the message buffer. In some embodiments, the automated context monitoring system may then aggregate the messages that remain in the message buffer and provide data associated with the aggregated messages to the LLM to cause the LLM to generate the second summary.

The automated context monitoring system may generate a transcript representing the chat session at the first state and/or the second state. For example, as illustrated above, the automated context monitoring system may receive customer input data and/or agent input data during a chat session at the first and/or second states of the chat session. The automated monitoring system may then combine the strings of text associated with the customer input data and/or the agent input data in the order in which they were transmitted (or received by the automated context monitoring system) to generate a transcript. In some embodiments, the automated context monitoring system continuously combines the strings of text to generate the transcript. In some embodiments, the automated context monitoring system may then provide data associated with the transcript to the LLM to cause the LLM to generate the second summary. Additionally, or alternatively, the automated context monitoring system may provide data associated with a portion of the transcript to the LLM to cause the LLM to generate the second summary.

For the second state of the chat session, the LLM may be executed on the first summary, the customer input data, and the agent input data. For example, the automated context monitoring system may generate data associated with the first summary and the one or more messages received during the second state of the chat session. The automated context monitoring system may then provide the data associated with the first summary, the customer input data, and the agent input data to the LLM to cause the LLM to generate an output. Additionally, or alternatively, the automated context monitoring system may provide data associated with a prompt to cause the LLM to compare the information represented by the first summary to information represented by the customer input data and the agent input data (e.g., the data received during the second state of the chat session). In this example, the LLM may provide as output a second summary or an indication that the information represented by the customer input data and the agent input data is the same as, or similar to, the information represented by the first summary. The automated context management system may then provide as output data associated with the second summary, where the second summary is based on (e.g., the same as, or similar to) the first summary.

The automated context monitoring system may determine that a transition has occurred. For example, the automated context monitoring system may determine that a transition has occurred between the first state of the chat session and the second state of the chat session. In some embodiments, the automated context monitoring system may determine that the transition has occurred based on the automated context monitoring system monitoring the agent chat interface. For example, where the agent provides input via the agent device to display a different chat session involving a different customer, the automated context monitoring system may determine that the agent provided such input and that the agent device transitioned to the different chat session involving the different customer. Additionally, or alternatively, where the agent provides input via the agent device to return to the display of the chat session involving the customer (referred to as an intervening chat session), the automated context monitoring system may determine that a transition has occurred during the chat session.

The automated context monitoring system may determine that the transition has occurred based on the automated context monitoring system determining that an amount of time has passed since the agent chat interface was updated. For example, the automated context monitoring system may determine that a most-recent message was received at a time based on the customer input data and the agent input data. The most recent message may be the most-recent message in a set of messages exchanged between the customer via the client device and the agent via the agent device. The automated context monitoring system may then determine that a difference between a current time and the time the most-recent message was received satisfies a threshold amount of time. In this example, the automated context monitoring system may then determine that the transition has occurred based on the determining that the difference between the current time and the time the most-recent message was received satisfies the threshold amount.

The automated context monitoring system generates the second summary based on the automated context monitoring system determining that the transition has occurred. For example, the automated context monitoring system may execute the LLM based on the customer input data and the agent input data at the second state to generate a second summary based on the automated context monitoring system determining that the transition has occurred. In some embodiments, the automated context monitoring system may execute the LLM based on the customer input data and the agent input data corresponding to the second state of the chat session. For example, the automated context monitoring system may determine that the customer input data is associated with one or more messages received during the second state of the chat session and that the agent input data is associated with one or more messages received during the second state of the chat session. The automated context monitoring system may then provide data associated with the messages received during the second state of the chat session to the LLM to cause the LLM to generate an output. In this case, the output may include data associated with the second summary.

The automated context monitoring system may obtain a second feature embedding. For example, the automated context monitoring system may obtain the second feature embedding based on the second summary. In examples, the automated context monitoring system may tokenize each word in the summary to generate the first feature embedding. In some examples, the automated context monitoring system may generate a set of vectors based on each word in the summary to generate the first feature embedding.

The automated context monitoring system may select a form file based on the second feature embedding. For example, the automated context monitoring system may select the form file from among the plurality of form files (discussed above). In some embodiments, the automated context monitoring system may select the form file based on the automated context monitoring system performing an embedding search. For example, the automated context monitoring system may compare the second feature embedding to the form files (e.g., to feature embeddings associated with the form files) and determine an embedding similarity (e.g., a value indicating a degree to which the second feature embedding matches the feature embeddings associated with the form files). The automated context monitoring system may then select a form file from among the form files based on the comparison.

Based on parsing the form files (similar to as described above), the automated context monitoring system may identify instances of field names that correspond to field names included in the second summary. For example, the automated context monitoring system may identify the instances of filed names in a form file corresponding to fields in the second summary and copy the information from the second summary into the form file. The automated context monitoring system may then update the agent chat interface based on the form file when filled with the information from the second summary.

At operation 208, the agent chat interface is updated based on the second summary. In some embodiments, the automated context monitoring system updates the agent chat interface. For example, the automated context monitoring system may update the agent chat interface based on the second summary. In some embodiments, the automated context monitoring system updates the GUI when generating the agent chat interface. For example, the automated context monitoring system may generate the second summary associated with the second state of the chat session and incorporate some or all of the content of the second summary into the GUI. In examples, the automated context monitoring system may update one or more fields represented in a form file associated with the GUI. This may be done in the case where the form file is consistent with the second summary (e.g., is confirmed as being the correct form file) and only one or more fields in the form file need to be updated based on the second summary. In this way, the automated context monitoring system may update only portions of the form file as needed, avoiding flickering of portions of the GUI when displayed to the agent via the agent device. In some embodiments, the automated context monitoring system may generate data associated with the updated GUI and provide the data associated with the GUI to the agent device to cause the display of the agent device to present the GUI (similar to as described above).

The automated context monitoring system updates the agent chat interface based on the second summary and the selected form file. For example, the automated context monitoring system may generate the agent chat interface by copying text included in the second summary that corresponds to the fields in the form file selected based on the embedding search involving the second feature embedding. The automated context monitoring system may then generate an agent chat interface based on the updated form file, generate data associated with a GUI based on the agent chat interface, and provide data associated with the agent chat interface to cause the display of the agent device to present the GUI (similar to as described above). In this example, the automated context monitoring system may generate a GUI that represents at least a portion of the form file selected using the second summary.

The automated context monitoring system may forgo updating the agent chat interface. For example, in the case where the automated context monitoring system determines that the first summary is the same as, or similar to, the second summary based on providing data associated with a prompt to cause the LLM to compare the information represented by the first summary to information represented by the customer input data and the agent input data (discussed above), the automated context monitoring system may determine to forgo updating the agent chat interface. In this way, the automated context monitoring system may avoid unnecessarily updating the agent chat interface when presented to the agent via the display of the agent device, thereby avoiding unnecessary user interface transitions (e.g., flickers and/or the like).

In some embodiments, when the automated context monitoring system provides data to the LLM to cause the LLM to generate an output representing the first or second summary, the automated context monitoring system may provide data associated with a prompt. The data associated with the prompt may be provided before, concurrently, or after the automated context monitoring system provides the data to the LLM (the customer input data and/or the agent input data) to cause the LLM to generate the output. In some embodiments, the prompt may cause the LLM to generate the first summary or the second summary. For example, the prompt may include a string of text one or more conditions (e.g., “generate a summary based on the following messages in a conversation”) that causes the LLM to analyze the messages and generate a summary (e.g., the first summary or the second summary) based on the messages and the one or more conditions. In some embodiments, the automated context monitoring system may receive the data associated with the prompt from the agent device. Additionally, or alternatively, the automated context monitoring system may receive the data associated with the prompt from a database in communication with the automated context monitoring system.

### Example Machine Learning Operations

To assist in understanding the present disclosure, some example concepts relevant to neural networks and machine learning (ML) are further discussed.

Generally, a neural network comprises a number of computation units (sometimes referred to as “neurons”). Each neuron receives an input value and applies a function to the input value to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which need not be discussed in detail here.

A deep neural network (DNN) is a type of neural network having multiple layers and/or a large number of neurons. The term DNN may encompass any neural network having multiple layers, including convolutional neural networks (CNNs), recurrent neural networks (RNNs), and multilayer perceptrons (MLPs), among others.

DNNs are often used as ML-based models for modeling complex behaviors (e.g., human language, image recognition, object classification, etc.) in order to improve accuracy of outputs (e.g., more accurate predictions) such as, for example, as compared with models with fewer layers. In the present disclosure, the term “ML-based model” or more simply “ML model” may be understood to refer to a DNN. Training a ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model. For example, to train a ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual, and non-subject-specific corpus may be created by extracting text from online webpages and/or publicly available social media posts. In another example, to train a ML model that is intended to classify images, the training dataset may be a collection of images. Training data may be annotated with ground truth labels (e.g., each data entry in the training dataset may be paired with a label) or may be unlabeled.

Training a ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or may be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training a ML model. Backpropagation is used to adjust (also referred to as update) the value of the parameters in the ML model, with the goal of optimizing the objective function. For example, a defined loss function is calculated by forward propagation of an input to obtain an output of the ML model and comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively, so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of a ML model typically involves further training the ML model on a number of data samples (which may be smaller in number/cardinality than those used to train the model initially) that closely target the specific task. For example, a ML model for generating natural language that has been trained generically on publicly-available text corpuses may be, e.g., fine-tuned by further training using the complete works of Shakespeare as training data samples (e.g., where the intended use of the ML model is generating a scene of a play or other textual content in the style of Shakespeare).

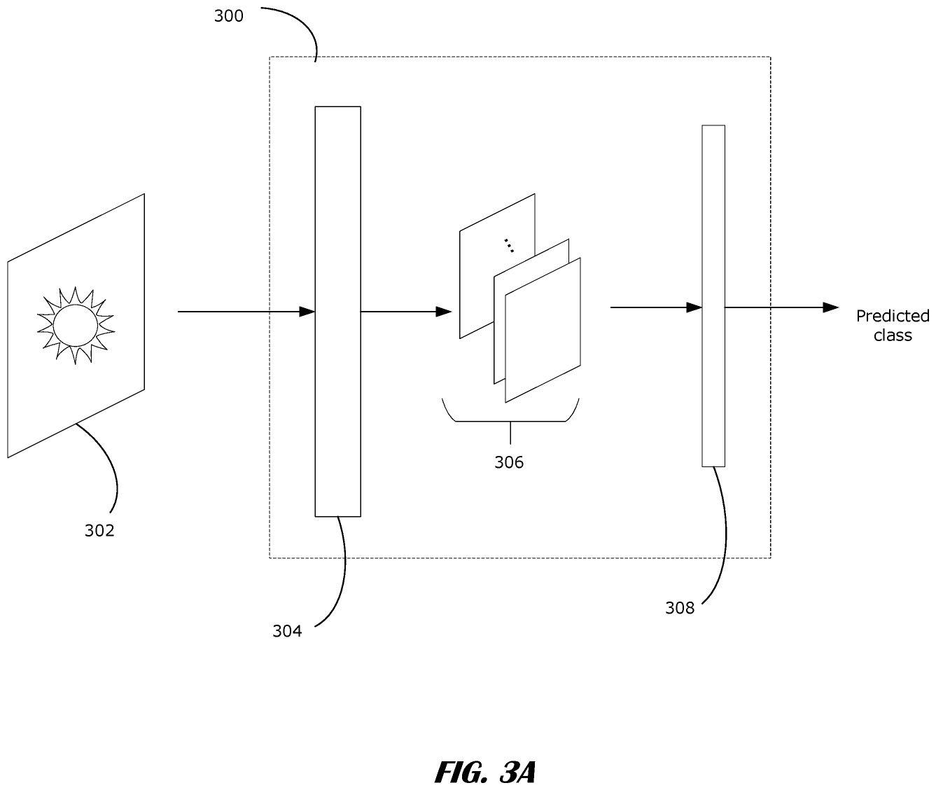

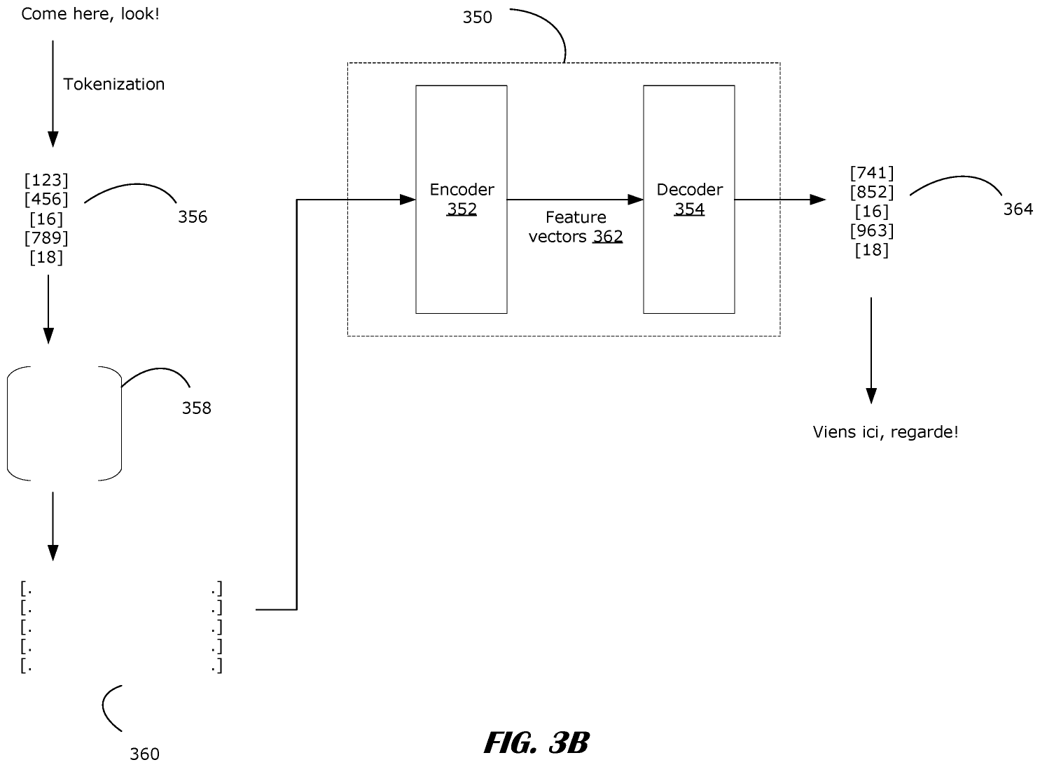

FIG. 3A shows a block diagram of a simplified convolutional neural network which may be used in examples of the present disclosure. Specifically, an example CNN 300 is shown, which is an example of a DNN that is commonly used for image processing tasks such as image classification, image analysis, object segmentation, etc. An input to the CNN 300 may be an image 302 (e.g., 2D color image). While a 2D image is illustrated by FIG. 3A, it will be understood that CNN 300 may be trained to process data associated with other types of information such as, for example, words or sets of words corresponding to word embeddings and/or the like.

The CNN 300 includes a plurality of layers that process the image 302 in order to generate an output, such as a predicted classification or predicted label for the image 302. For simplicity, only a few layers of the CNN 300 are illustrated including at least one convolutional layer 304. The convolutional layer 304 performs convolution processing, which may involve computing a dot product between the input to the convolutional layer 304 and a convolution kernel. A convolutional kernel is typically a 2D matrix of learned parameters that is executed to the input in order to extract image features. Different convolutional kernels may be executed to extract different image information, such as shape information, color information, etc.

The output of the convolution layer 304 is a set of feature maps 306 (sometimes referred to as activation maps). Each feature map 306 generally has smaller width and height than the image 302. The set of feature maps 306 encode image features that may be processed by subsequent layers of the CNN 300, depending on the design and intended task for the CNN 300. In this example, a fully connected layer 308 processes the set of feature maps 306 in order to perform a classification of the image, based on the features encoded in the set of feature maps 306. The fully connected layer 308 contains learned parameters that, when executed to the set of feature maps 306, outputs a set of probabilities representing the likelihood that the image 302 belongs to each of a defined set of possible classes. The class having the highest probability may then be outputted as the predicted classification for the image 302.

In general, a CNN may have different numbers and different types of layers, such as multiple convolution layers, max-pooling layers and/or a fully connected layer, among others. The parameters of the CNN may be learned through training, using data having ground truth labels specific to the desired task (e.g., class labels if the CNN is being trained for a classification task, pixel masks if the CNN is being trained for a segmentation task, text annotations if the CNN is being trained for a captioning task, etc.), as discussed above.

Some concepts in ML-based language models are now discussed. It may be noted that, while the term “language model” has been commonly used to refer to a ML-based language model, there could exist non-ML language models. In the present disclosure, the term “language model” may be used as shorthand for ML-based language model (e.g., a language model that is implemented using a neural network or other ML architecture), unless stated otherwise. For example, unless stated otherwise, “language model” encompasses LLMs.

A language model may use a neural network (typically a DNN) to perform natural language processing (NLP) tasks such as language translation, image captioning, grammatical error correction, and language generation, among others. A language model may be trained to model how words relate to each other in a textual sequence, based on probabilities. A language model may contain hundreds of thousands of learned parameters or in the case of a large language model (LLM) may contain millions or billions of learned parameters or more.

In recent years, there has been interest in a type of neural network architecture, referred to as a transformer, for use as language models. For example, the Bidirectional Encoder Representations from Transformers (BERT) model, the Transformer-XL model and the Generative Pre-trained Transformer (GPT) models are types of transformers. A transformer is a type of neural network architecture that uses self-attention mechanisms in order to generate predicted output based on input data that has some sequential meaning (e.g., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

FIG. 3B shows a block diagram of a simplified transformer neural network which may be used in examples of the present disclosure. The diagram includes an example transformer 350, and a simplified discussion of its operation is now provided. The transformer 350 includes an encoder 352 (which may comprise one or more encoder layers/blocks connected in series) and a decoder 354 (which may comprise one or more decoder layers/blocks connected in series). Generally, the encoder 352 and the decoder 354 each include a plurality of neural network layers, at least one of which may be a self-attention layer. The parameters of the neural network layers may be referred to as the parameters of the language model.

The transformer 350 may be trained on a text corpus that is labeled (e.g., annotated to indicate verbs, nouns, etc.) or unlabeled. LLMs may be trained on a large unlabeled corpus. Some LLMs may be trained on a large multi-language, multi-domain corpus, to enable the model to be versatile at a variety of language-based tasks such as generative tasks (e.g., generating human-like natural language responses to natural language input).

An example of how the transformer 350 may process textual input data is now described. Input to a language model (whether transformer-based or otherwise) typically is in the form of natural language as may be parsed into tokens. It should be appreciated that the term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph, etc.) into a sequence of shorter segments that are converted to numerical representations referred to as tokens (or “compute tokens”). Typically, a token may be an integer that corresponds to the index of a text segment (e.g., a word) in a vocabulary dataset. Often, the vocabulary dataset is arranged by frequency of use. Commonly occurring text, such as punctuation, may have a lower vocabulary index in the dataset and thus be represented by a token having a smaller integer value than less commonly occurring text. Tokens frequently correspond to words, with or without whitespace appended. In some examples, a token may correspond to a portion of a word. For example, the word “lower” may be represented by a token for [low] and a second token for [er]. In another example, the text sequence “Come here, look!” may be parsed into the segments [Come], [here], [,], [look] and [!], each of which may be represented by a respective numerical token. In addition to tokens that are parsed from the textual sequence (e.g., tokens that correspond to words and punctuation), there may also be special tokens to encode non-textual information. For example, a [CLASS] token may be a special token that corresponds to a classification of the textual sequence (e.g., may classify the textual sequence as a poem, a list, a paragraph, etc.), a [EOT] token may be another special token that indicates the end of the textual sequence, other tokens may provide formatting information, etc.

In FIG. 3B, a short sequence of tokens 356 corresponding to the text sequence “Come here, look!” is illustrated as input to the transformer 350. While the example “Come here, look!” is provided as an example, it will be understood that the customer input data and/or the agent input data described with respect to FIG. 4 (including portions thereof) and/or data associated with transcripts (including portions thereof) may be provided to the transformer 350 to cause the transformer 350 to generate an output based on the data provided the transformer 350. Additionally, or alternatively, data associated with prompts and/or summaries described with respect to FIG. 4 may also be provided to the transformer 350 to generate the outputs described above with respect to FIG. 4.

With continued reference to FIG. 3B, tokenization of the text sequence into the tokens 356 may be performed by some pre-processing tokenization module such as, for example, a byte pair encoding tokenizer (the “pre” referring to the tokenization occurring prior to the processing of the tokenized input by the LLM), which is not shown in FIG. 3B for simplicity. In general, the token sequence that is inputted to the transformer 350 may be of any length up to a maximum length defined based on the dimensions of the transformer 350 (e.g., such a limit may be 2048 tokens in some LLMs). Each token 356 in the token sequence is converted into an embedding vector 360 (also referred to simply as an embedding). An embedding 360 is a learned numerical representation (such as, for example, a vector) of a token that captures some semantic meaning of the text segment represented by the token 356. The embedding 360 represents the text segment corresponding to the token 356 in a way such that embeddings corresponding to semantically-related text are closer to each other in a vector space than embeddings corresponding to semantically-unrelated text. For example, assuming that the words “look”, “see”, and “cake” each correspond to, respectively, a “look” token, a “see” token, and a “cake” token when tokenized, the embedding 360 corresponding to the “look” token will be closer to another embedding corresponding to the “see” token in the vector space, as compared to the distance between the embedding 360 corresponding to the “look” token and another embedding corresponding to the “cake” token. The vector space may be defined by the dimensions and values of the embedding vectors. Various techniques may be used to convert a token 356 to an embedding 360. For example, another trained ML model may be used to convert the token 356 into an embedding 360. In particular, another trained ML model may be used to convert the token 356 into an embedding 360 in a way that encodes additional information into the embedding 360 (e.g., a trained ML model may encode positional information about the position of the token 356 in the text sequence into the embedding 360). In some examples, the numerical value of the token 356 may be used to look up the corresponding embedding in an embedding matrix 358 (which may be learned during training of the transformer 350).

The generated embeddings 360 are input into the encoder 352. The encoder 352 serves to encode the embeddings 360 into feature vectors 362 that represent the latent features of the embeddings 360. The encoder 352 may encode positional information (e.g., information about the sequence of the input) in the feature vectors 362. The feature vectors 362 may have very high dimensionality (e.g., on the order of thousands or tens of thousands), with each element in a feature vector 362 corresponding to a respective feature. The numerical weight of each element in a feature vector 362 represents the importance of the corresponding feature. The space of all possible feature vectors 362 that can be generated by the encoder 352 may be referred to as the latent space or feature space.

Conceptually, the decoder 354 is designed to map the features represented by the feature vectors 362 into meaningful output, which may depend on the task that was assigned to the transformer 350. For example, if the transformer 350 is used for a translation task, the decoder 354 may map the feature vectors 362 into text output in a target language different from the language of the original tokens 356. Generally, in a generative language model, the decoder 354 serves to decode the feature vectors 362 into a sequence of tokens. The decoder 354 may generate output tokens 364 one by one. Each output token 364 may be fed back as input to the decoder 354 in order to generate the next output token 364. By feeding back the generated output and applying self-attention, the decoder 354 is able to generate a sequence of output tokens 364 that has sequential meaning (e.g., the resulting output text sequence is understandable as a sentence and obeys grammatical rules). The decoder 354 may generate output tokens 364 until a special [EOT] token (indicating the end of the text) is generated. The resulting sequence of output tokens 364 may then be converted to a text sequence in post-processing. For example, each output token 364 may be an integer number that corresponds to a vocabulary index. By looking up the text segment using the vocabulary index, the text segment corresponding to each output token 364 can be retrieved, the text segments can be concatenated together and the final output text sequence (in this example, “Viens ici, regarde!”) can be obtained.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that may be considered to be an encoder-only language model. A decoder-only language model accepts embeddings as input and may use auto-regression to generate an output text sequence. Transformer-XL and GPT-type models may be language models that are considered to be decoder-only language models.

Because GPT-type language models tend to have a large number of parameters, these language models may be considered LLMs. An example GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2048 input tokens), and is able to generate a large number of tokens as output (e.g., up to 2048 tokens). GPT-3 has been trained as a generative model, meaning that it can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs and generating chat-like outputs.

A computing system may access a remote language model (e.g., a cloud-based language model), such as ChatGPT or GPT-3, via a software interface (e.g., an application programming interface (API)). Additionally, or alternatively, such a remote language model may be accessed via a network such as, for example, the Internet. In some implementations such as, for example, potentially in the case of a cloud-based language model, a remote language model may be hosted by a computer system as may include a plurality of cooperating (e.g., cooperating via a network) computer systems such as may be in, for example, a distributed arrangement. Notably, a remote language model may employ a plurality of processors (e.g., hardware processors such as, for example, processors of cooperating computer systems). Indeed, processing of inputs by an LLM may be computationally expensive/may involve a large number of operations (e.g., many instructions may be executed/large data structures may be accessed from memory) and providing output in a required timeframe (e.g., real-time or near real-time) may require the use of a plurality of processors/cooperating computing devices as discussed above.

Inputs to an LLM may be referred to as a prompt, which is a natural language input that includes instructions to the LLM to generate a desired output. A computing system may generate a prompt that is provided as input to the LLM via its API. As described above, the prompt may optionally be processed or pre-processed into a token sequence prior to being provided as input to the LLM via its API. A prompt can include one or more examples of the desired output, which provides the LLM with additional information to enable the LLM to better generate output according to the desired output. Additionally, or alternatively, the examples included in a prompt may provide inputs (e.g., example inputs) corresponding to/as may be expected to result in the desired outputs provided. A one-shot prompt refers to a prompt that includes one example, and a few-shot prompt refers to a prompt that includes multiple examples. A prompt that includes no examples may be referred to as a zero-shot prompt.

FIG. 4 shows a block diagram of an example computing system which may be used to implement examples of the present disclosure. The example computing system 400, which may be used to implement examples of the present disclosure, such as a prompt generation engine to generate prompts to be provided as input to a language model such as an LLM. Additionally, or alternatively, one or more instances of the example computing system 400 may be employed to execute the LLM. For example, a plurality of instances of the example computing system 400 may cooperate to provide output using an LLM in manners as discussed above.

The example computing system 400 includes at least one processing unit, such as a processor 402, and at least one physical memory 404. The processor 402 may be, for example, a central processing unit, a microprocessor, a digital signal processor, an application-specific integrated circuit (ASIC), a field-programmable gate array (FPGA), a dedicated logic circuitry, a dedicated artificial intelligence processor unit, a graphics processing unit (GPU), a tensor processing unit (TPU), a neural processing unit (NPU), a hardware accelerator, or combinations thereof. The memory 404 may include a volatile or non-volatile memory (e.g., a flash memory, a random access memory (RAM), and/or a read-only memory (ROM)). The memory 404 may store instructions for execution by the processor 402, to the computing system 400 to carry out examples of the methods, functionalities, systems and modules disclosed herein.

The computing system 400 may also include at least one network interface 406 for wired and/or wireless communications with an external system and/or network (e.g., an intranet, the Internet, a P2P network, a WAN and/or a LAN). A network interface may enable the computing system 400 to carry out communications (e.g., wireless communications) with systems external to the computing system 400, such as a language model residing on a remote system.

The computing system 400 may optionally include at least one input/output (I/O) interface 408, which may interface with optional input device(s) 410 and/or optional output device(s) 412. Input device(s) 410 may include, for example, buttons, a microphone, a touchscreen, a keyboard, etc. Output device(s) 412 may include, for example, a display, a speaker, etc. In this example, optional input device(s) 410 and optional output device(s) 412 are shown external to the computing system 400. In other examples, one or more of the input device(s) 410 and/or output device(s) 412 may be an internal component of the computing system 400.

A computing system, such as the computing system 400 of FIG. 2, may access a remote system (e.g., a cloud-based system) to communicate with a remote language model or LLM hosted on the remote system such as, for example, using an application programming interface (API) call. The API call may include an API key to enable the computing system to be identified by the remote system. The API call may also include an identification of the language model or LLM to be accessed and/or parameters for adjusting outputs generated by the language model or LLM, such as, for example, one or more of a temperature parameter (which may control the amount of randomness or “creativity” of the generated output) (and/or, more generally some form of random seed as serves to introduce variability or variety into the output of the LLM), a minimum length of the output (e.g., a minimum of 10 tokens) and/or a maximum length of the output (e.g., a maximum of 1000 tokens), a frequency penalty parameter (e.g., a parameter which may lower the likelihood of subsequently outputting a word based on the number of times that word has already been output), a “best of” parameter (e.g., a parameter to control the number of times the model will use to generate output after being instructed to, e.g., produce several outputs based on slightly varied inputs). The prompt generated by the computing system is provided to the language model or LLM and the output (e.g., token sequence) generated by the language model or LLM is communicated back to the computing system. In other examples, the prompt may be provided directly to the language model or LLM without requiring an API call. For example, the prompt could be sent to a remote LLM via a network such as, for example, as or in message (e.g., in a payload of a message).

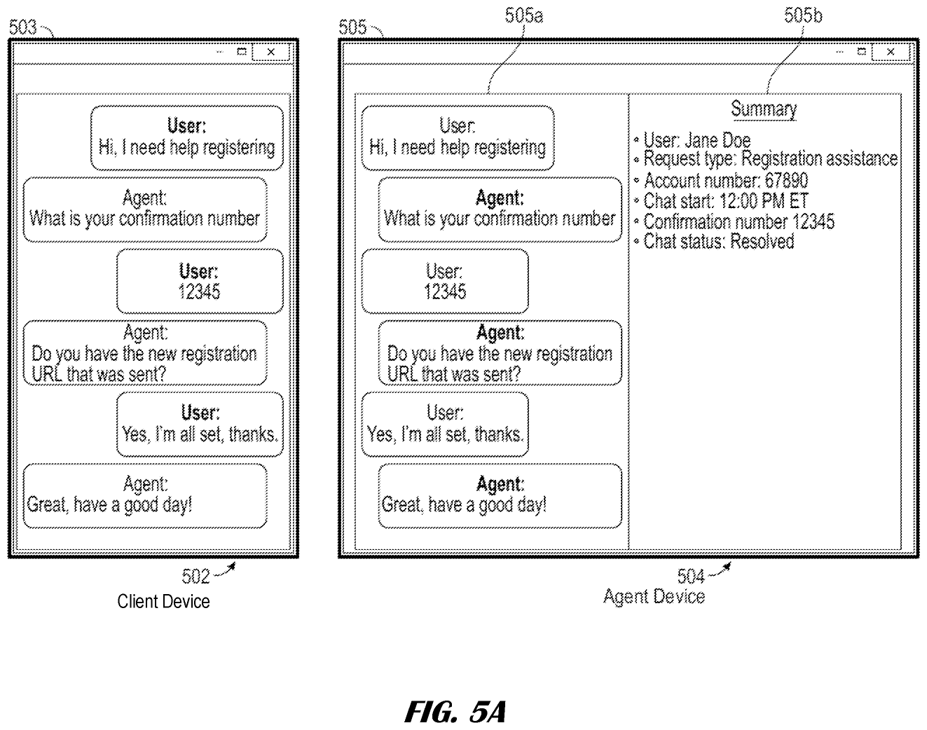

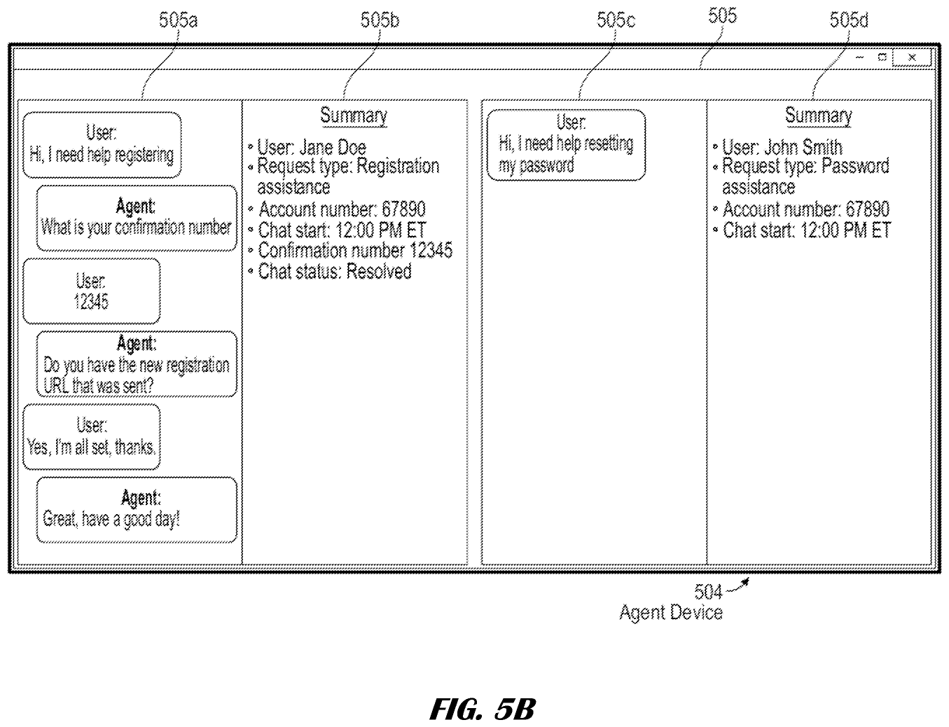

FIG. 5A shows an example set of GUIs which may be generated when implementing examples of the present disclosure. More specifically, FIG. 5A shows a client device 502 and an agent device 504. The client device 502 may be the same as, or similar to, the client device 102 (e.g., customer device 102a, merchant device 102b) of FIG. 1 and may include one or more components of the computing system 400 of FIG. 4. The agent device 504 may be the same as, or similar to, the agent device 104 of FIG. 1 and may include one or more components of the computing system 400 of FIG. 4. The client device 502 includes a user interface which is displayed via a window 503 of the client device 502. The agent device 504 includes a user interface which is displayed via a window 505, the window 505 having a first region 505a and a second region 505b.

With continued reference to FIG. 5A, the window 503 of the client device 502 may represent a GUI including one or more messages (illustrated as chat bubbles) communicated between a user (associated with the client device 502) and an agent (associated with the agent device 504) during a chat session. Similarly, the window 505 of the agent device 504 may represent a GUI (associated with an agent chat interface) that is similar to the GUI including the one or more messages. As the user and the agent provide input to the client device 502 and the agent device 504, respectively, each device may communicate with one another via a network to exchange data associated with the one or more messages (referred to as customer input data and agent input data, respectively). The client device 502 and the agent device 504 may then update the corresponding GUI (e.g., by updating the window 503 and the first region 505a of the window 505, respectively) periodically and/or continuously.

In some implementations, the client device 502 is associated with an individual such as a user, a customer, a device owner, an account owner, an individual associated with a merchant, and/or the like that, in examples, is requesting assistance from an agent. In examples where the user is a customer, a device owner, an account owner and/or the like, the user may interact with the client device by providing input that is then communicated to the agent device 504 so as to enable an agent to communicate with the user. In these examples, the agent may be an individual associated with a merchant that is assisting in the involved transaction. In other examples where the user is an individual associated with a merchant, the user may interact with the client device by providing input that is then communicated to the agent device 504 so as to enable the agent to assist the merchant. In these examples where the user is a merchant, the agent may be an individual associated with a service provider system. In some implementations, the agent device 504 is associated with an individual associated with an organization that supports one or more features and/or one or more products associated with the client.

As the agent device 504 receives data associated with the one or more messages that are communicated (e.g., transmitted) by the client device 502 based on the client device 502 receiving input from the user, the agent device 504 may update the second region 505b of the window 505. More specifically, the agent device 504 may determine a summary and the agent device 504 may update the second region 505b of the window 505 to include the information associated with the summary. In some examples, the agent device 504 may determine the summary based on the agent device providing data associated with the messages communicated between the client device 502 and the agent device 504 to an ML model (e.g., a LLM and/or the like) as described herein to cause the ML model to generate an output. The client device 502 may then update the second region 505b of the window 505 to include the information associated with the one or more fields of the summary based on the output of the ML model.

As the agent device 504 receives data associated with the one or more messages that are communicated by (e.g., transmitted by) the client device 502 based on the client device 502 receiving input from the user, the agent device 504 may update the second region 505b of the window 505. More specifically, the agent device 504 may determine one or more updates to the summary (sometimes referred to in sequence as a second summary and so on) based on the data associated with the one or more messages and the agent device 504 may update the second region 505b of the window 505 to include the information associated with the updated summary. In some examples, the agent device 504 may determine the one or more fields based on the agent device providing data associated with the messages to the ML model to cause the ML model to generate an output. The client device 502 may then update the second region 505b of the window 505 to include the information associated with the one or more fields of the summary based on the output of the ML model.

FIG. 5B shows an example GUI which may be generated when implementing examples of the present disclosure. More specifically, a GUI associated with the first region 505a and the second region 505b are shown where the first region 505a and the second region 505b are associated with a chat session involving the client device 502 of FIG. 5A. In addition, a GUI associated with a third region 505c and a fourth region 505d are shown where the third region 505c and the fourth region 505d are associated with a chat session involving another client device which may be similar to the client device 502 of FIG. 5A. The third region 505c and the fourth region 505d may be updated by the agent device 504 similar to how the first region 505a and the second region 505b are updated based on communication of data associated with one or more messages with another client device. In this way, an agent associated with the agent device 504 may manage multiple chat sessions simultaneously.

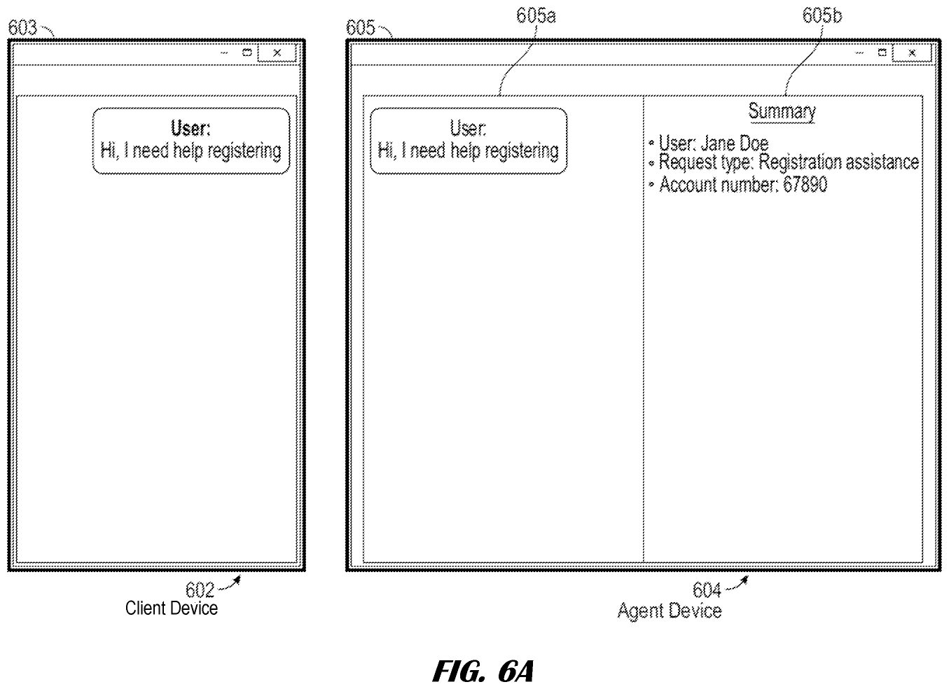

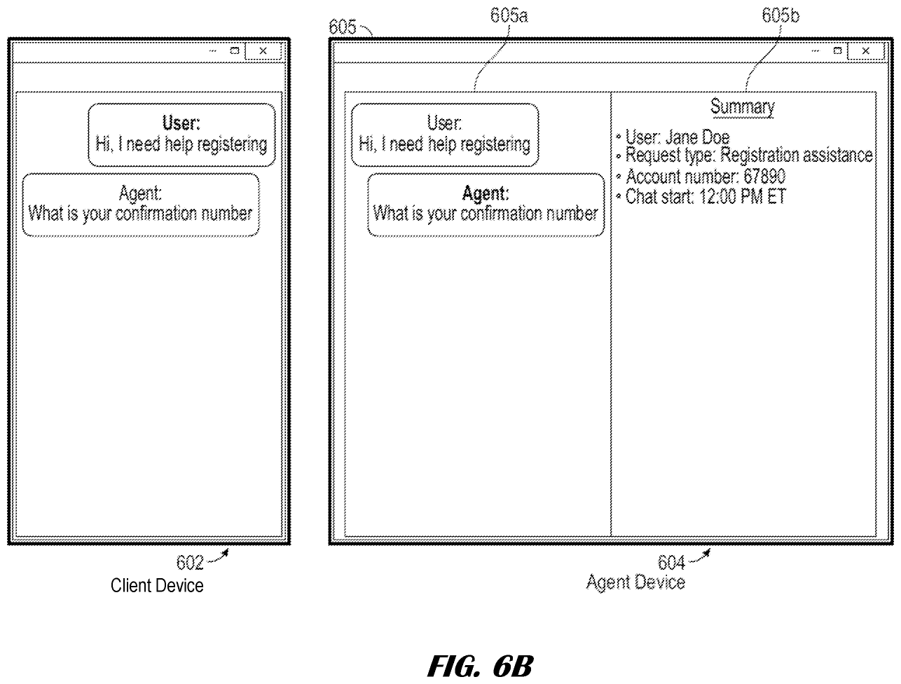

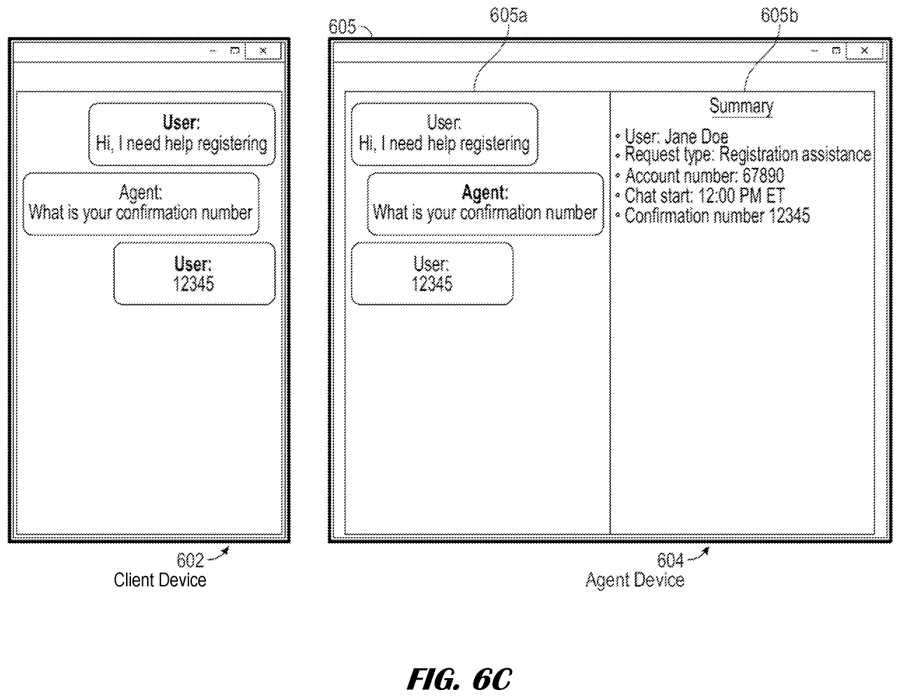

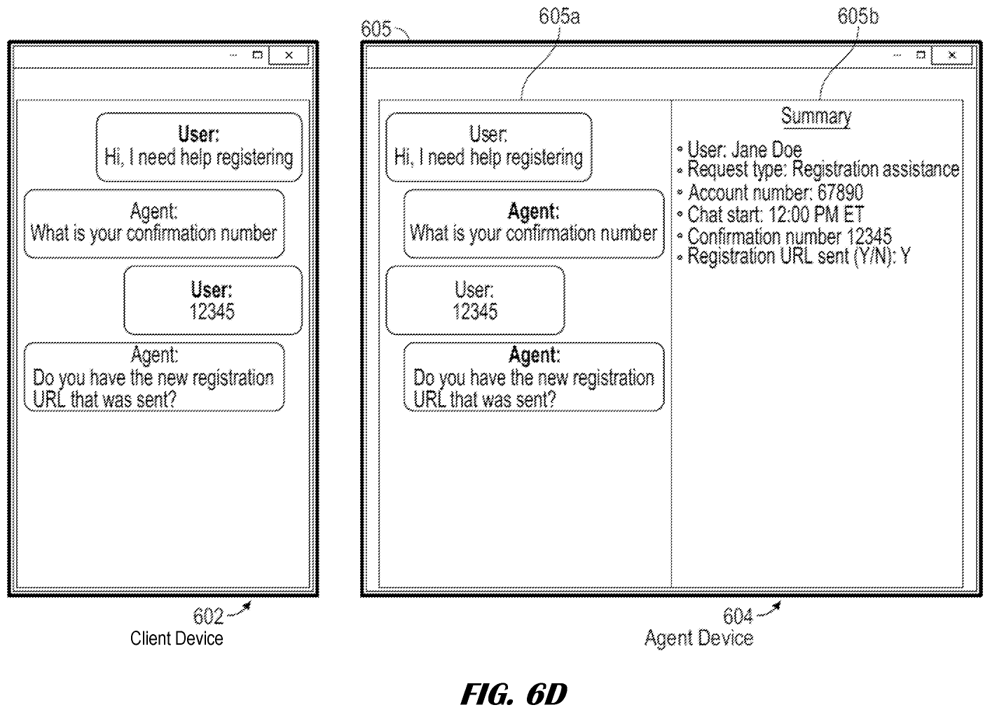

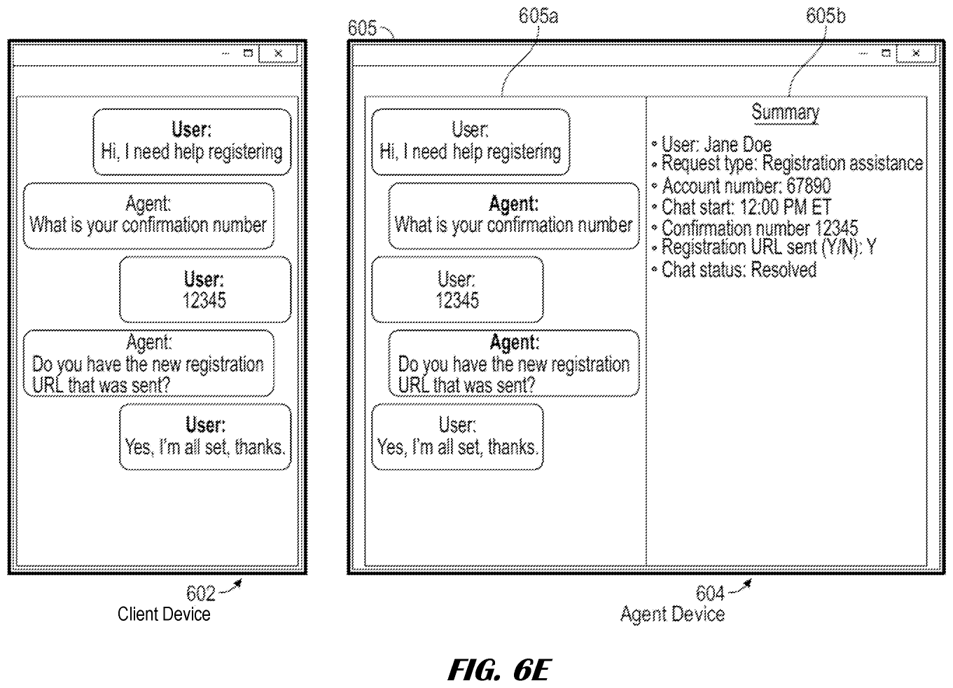

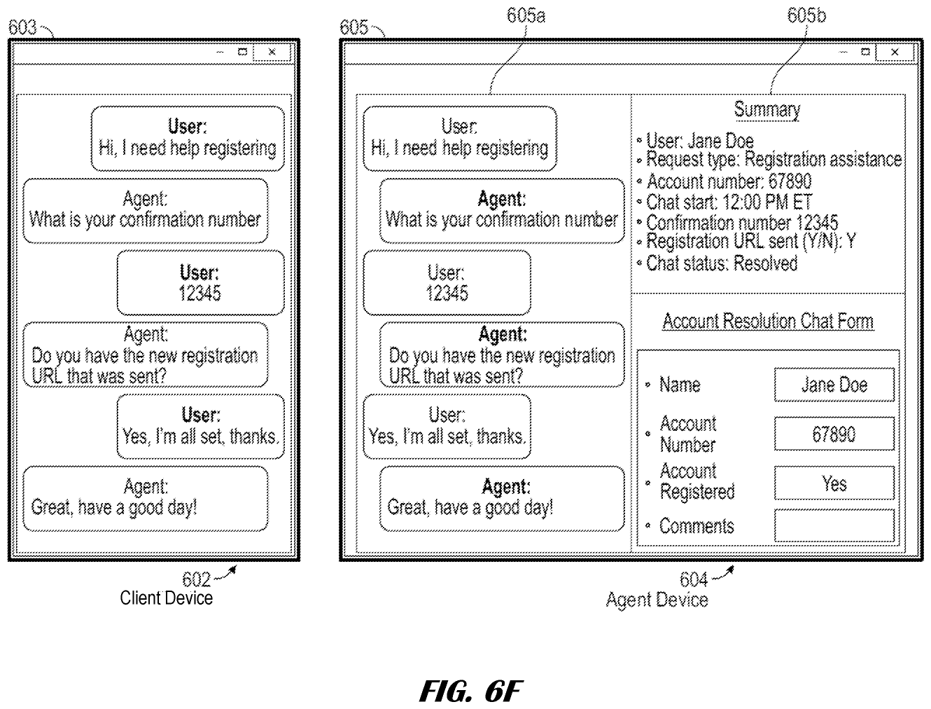

FIGS. 6A-6F show an example set of GUIs which may be generated when implementing examples of the present disclosure. More specifically, FIGS. 6A-6F show a client device 602 and an agent device 604. The client device 602 may be the same as, or similar to, the client device 102 of FIG. 1 and/or the client device 502 of FIGS. 5A-5B and may include one or more components of the computing system 400 of FIG. 4. The agent device 604 may be the same as, or similar to, the client device 102 of FIG. 1 and/or the agent device 504 of FIGS. 5A-5B and may include one or more components of the computing system 400 of FIG. 4. The client device 602 includes a user interface which is displayed via a window 603 of the client device 602. The agent device 604 includes a user interface which is displayed via a window 605, the window 605 having a first region 605a and a second region 605b.

In some implementations, the client device 602 is associated with an individual such as a user, a customer, a device owner, an account owner, an individual associated with a merchant, and/or the like that, in examples, is requesting assistance from an agent. In examples where the user is a customer, a device owner, an account owner and/or the like, the user may interact with the client device 602 by providing input that is then communicated to the agent device 604 so as to enable an agent to communicate with the user. In these examples, the agent may be an individual associated with a merchant that is assisting in the involved transaction. In other examples where the user is an individual associated with a merchant, the user may interact with the client device by providing input that is then communicated to the agent device 604 so as to enable the agent to assist the merchant. In these examples where the user is a merchant, the agent may be an individual associated with a service provider system. In some implementations, the agent device 604 is associated with an individual associated with an organization that supports one or more features and/or one or more products associated with the client.

With continued reference to FIG. 6A, the window 603 of the client device 602 may represent a GUI including a message (illustrated as a chat bubble). As illustrated, the message is an initial message received based on user input at the client device 602 and transmitted as data associated with the initial message to the agent device 604. The window 605 of the agent device 604 includes a first region 605a and a second region 605b. The first region 605a of the agent device 604 similarly represents a GUI including the message. The second window 605B of the agent device 604 represents a GUI including a summary that is generated by the agent device 604 based at least on the data associated with the one or more messages communicated between the client device 602 and the agent device 604.

Referring now to FIGS. 6B-6E, as the client device 602 and the agent device 604 receive input from the user and the agent, respectively, during a conversation. Each device then generates and transmits data associated with the one or more messages to the other to enable each device to update the window 503 and the first region 505a of the window 505, respectively, during the conversation. In addition, the agent device 604 updates the second region 505b of the window 505 based on the messages communicated between the client device 602 and the agent device 604. In examples, the agent device 604 may provide data associated with the information communicated during the chat session to an ML model to cause the ML model to generate and/or update the summary. Additionally, or alternatively, the agent device 604 may provide data associated with previously-generated summaries to the ML model to cause the ML model to generate and/or update the summary.

Referring now to FIG. 6F, the agent device 604 determines that the conversation has concluded and identifies a relevant form file (referred to in the illustrative example as an “Account Resolution Chat Form”) to be completed by the agent. The agent device 604 may identify the form file using, for example, the ML model. The agent device 604 then presents the form via the second region 605b of the window 605. While illustrated in the bottom right of the window 605, it will be understood that the form may be positioned anywhere within the window 605 and, in examples, so as to not obscure the portion of the window corresponding to the summary. In some implementations, the agent device 604 may prepopulate one or more fields of the form file. For example, the agent device 604 may prepopulate the one or more fields of the form file based on the summary as last updated by the agent device after the final message is communicated between the client device 602 and the agent device 604. Additionally, or alternatively, the agent device 604 may prepopulate the one or more fields of the form file based on the agent device 604 providing data associated with the form file, data associated with the summary, and/or data associated with the one or more messages communicated between the client device 602 and the agent device 604 to the ML model to cause the ML model to generate an output. In this example, the output of the ML model may include data associated with the prepopulated form file. Once the agent device 604 identifies either the form or the prepopulated form file, the agent device may update the window 605 to represent at least a portion of the form file. In examples, the agent device 604 may further receive input from the agent and the agent device 604 may update the fields of the form file based on the input from the agent.

In an embodiment, a computer-implemented method comprises: receiving, by a computer, customer input data from a client device and agent input data from an agent device during a chat session; for a first state of the chat session, executing, by the computer, a large language model on the customer input data and the agent input data at the first state to generate a first summary; and updating, by the computer, an agent chat interface of the agent device based on the first summary; and for a second state of the chat session, executing, by the computer, the large language model on the customer input data and the agent input data at the second state to generate a second summary; and updating, by the computer, the agent chat interface based on the second summary.

Executing the large language model on the customer input data and the agent input data at the second state to generate a second summary may comprise: executing, by the computer, the large language model on the first summary, the customer input data, and the agent input data at the second state to generate the second summary.

The method may further comprise: determining, by the computer, that a transition has occurred between the first state of the chat session and the second state of the chat session, the transition associated with an indication that the agent chat interface was updated based on an intervening chat session, wherein, when executing the large language model during the second state of the chat session, the large language model is executed based on determining that the transition has occurred between the first state of the chat session and the second state of the chat session.

The method may further comprise: determining, by the computer, that a transition has occurred between the first state of the chat session and the second state of the chat session, the transition associated with an indication that an amount of time has passed since the agent chat interface was updated during the first state of the chat session, the amount of time satisfying a threshold amount of time, wherein, when executing the large language model during the second state of the chat session, the large language model is executed based on determining that the transition has occurred between the first state of the chat session and the second state of the chat session.

The customer input data corresponding to the first state may be associated with a first message and the method may further comprise: determining, by the computer and during the second state, that the customer input data corresponding to the second state is associated with a second message, wherein, when executing the large language model during the second state of the chat session, the large language model is executed based on receiving the customer input data that is associated with the second message.

The method may further comprise: obtaining, by the computer, a first feature embedding from the first summary; and selecting, by the computer, a form file from a plurality of form files stored in a database based on an embedding search using the first feature embedding against the database, wherein updating the agent chat interface comprises: updating the agent chat interface of the agent device based on the form file selected using the first summary.

Updating the agent chat interface of the agent device based on the form file selected using the first summary may comprise: generating, by the computer, graphical user interface (GUI) data associated with a GUI based on the form file selected using the first summary, the GUI representing at least a portion of the form file selected using the first summary.

The method may further comprising, at the second state: obtaining, by the computer, a second feature embedding from the second summary; selecting, by the computer, a second form file from the plurality of form files stored in the database based on a second embedding similarity between the second feature embedding and a further feature embedding of the form file, the second embedding similarity satisfying a match threshold; and updating, by the computer, the agent chat interface of the agent device based on the second form file selected using the second summary.

Updating the agent chat interface of the agent device based on the second form file selected using the second summary may comprise: updating, by the computer, the GUI based on the second form file from the plurality of form files stored in the database, the GUI representing at least a portion of the second form file selected using the second summary; generating, by the computer, second GUI data associated with the GUI based on updating the GUI.

The method may further comprise: parsing, by the computer, a form file into a plurality of fields, each field comprising a field name; and identifying, by the computer, an instance of the field name of at least one field in at least one of the first summary or the second summary.

Receiving the customer input data from the client device may comprise: receiving, by the computer, customer input data from a plurality of client devices that are associated with distinct customers, the plurality of client devices corresponding to a plurality of chat sessions that are simultaneously performed, and updating, by the computer, the agent chat interface for the agent device based on the plurality of chat sessions.

The method may further comprise: generating, by the computer during the chat session, a transcript of the chat session based on the customer input data and the agent input data, wherein the first summary is generated based on a first portion of the transcript at the first state, and wherein the second summary is generated based on a second portion of the transcript at the second state.

The method may further comprise: determining, by the computer, a plurality of messages associated with the customer input data and the agent input data corresponding to the first state of the chat session; and updating, for the first state of the chat session and by the computer, a message buffer comprising a predetermined number of messages from among the plurality of messages corresponding to the first state of the chat session. The computer may execute the large language model on the customer input data and the agent input data corresponding to the predetermined number of messages in the message buffer to generate the first summary.

The method may further comprise: determining, by the computer, a plurality of messages associated with the customer input data and the agent input data corresponding to the first state of the chat session and the second state of the chat session; and updating, by the computer, a message buffer comprising a predetermined number of messages from among the plurality of messages corresponding to the first state of the chat session or the second state of the chat session. The computer may execute the large language model on the customer input data and the agent input data corresponding to the predetermined number of messages in the message buffer to generate the second summary.

Executing the large language model on the customer input data and the agent input data at the first state to generate the first summary may comprise: generating, by the computer, one or more outputs associated with the first summary by executing the large language model on a prompt response, the customer input data, and the agent input data; and obtaining, by the computer, the one or more outputs from the large language model, the output associated with the first summary, wherein the prompt response includes input text indicating one or more conditions for the large language model to process the customer input data and the agent input data based on the one or more conditions.

In an embodiment, a computer system comprises: a server comprising a processor configured to: receive customer input data from a client device and agent input data from an agent device during a chat session; for a first state of the chat session, execute a large language model on the customer input data and the agent input data at the first state to generate a first summary; and update an agent chat interface of the agent device based on the first summary; and for a second state of the chat session, execute the large language model on the customer input data and the agent input data at the second state to generate a second summary; and update the agent chat interface based on the second summary.

When executing the large language model on the customer input data and the agent input data at the second state to generate a second summary the processor may be configured to: execute the large language model on the first summary, the customer input data, and the agent input data at the second state to generate the second summary.

The processor may be further configured to: determine that a transition has occurred between the first state of the chat session and the second state of the chat session, the transition associated with an indication that the agent chat interface was updated based on an intervening chat session, wherein, when executing the large language model during the second state of the chat session, the large language model is executed based on determining that the transition has occurred between the first state of the chat session and the second state of the chat session.

The processor may be further configured to: determine that a transition has occurred between the first state of the chat session and the second state of the chat session, the transition associated with an indication that an amount of time has passed since the agent chat interface was updated during the first state of the chat session, the amount of time satisfying a threshold amount of time, wherein, when executing the large language model during the second state of the chat session, the large language model is executed based on determining that the transition has occurred between the first state of the chat session and the second state of the chat session.

The customer input data corresponding to the first state may be associated with a first message. The processor may be further configured to: determine, during the second state, that the customer input data corresponding to the second state is associated with a second message, wherein, when executing the large language model during the second state of the chat session, the large language model is executed based on receiving the customer input data that is associated with the second message.

The processor may be further configured to: obtain a first feature embedding from the first summary; and select a form file from a plurality of form files stored in a database based on an embedding search using the first feature embedding against the database, wherein updating the agent chat interface comprises: updating the agent chat interface of the agent device based on the form file selected using the first summary.

When updating the agent chat interface of the agent device based on the form file selected using the first summary the processor may be configured to generate graphical user interface (GUI) data associated with a GUI based on the form file selected using the first summary, the GUI representing at least a portion of the form file selected using the first summary.

The processor may be further configured to, at the second state: obtain a second feature embedding from the second summary; select a second form file from the plurality of form files stored in the database based on a second embedding similarity between the second feature embedding and a further feature embedding of the form file, the second embedding similarity satisfying a match threshold; and update the agent chat interface of the agent device based on the second form file selected using the second summary.

When updating the agent chat interface of the agent device based on the second form file selected using the second summary, the processor may be configured to: update the GUI based on the second form file from the plurality of form files stored in the database, the GUI representing at least a portion of the second form file selected using the second summary; generating, by the computer, second GUI data associated with the GUI based on updating the GUI.

The processor may be further configured to parse a form file into a plurality of fields, each field comprising a field name; and identify an instance of the field name of at least one field in at least one of the first summary or the second summary.

When receiving the customer input data from the client device, the processor may be configured to: receive customer input data from a plurality of client devices that are associated with distinct customers, the plurality of client devices corresponding to a plurality of chat sessions that are simultaneously performed, and update the agent chat interface for the agent device based on the plurality of chat sessions.

The processor may be further configured to: generate, during the chat session, a transcript of the chat session based on the customer input data and the agent input data, wherein the first summary is generated based on a first portion of the transcript at the first state, and wherein the second summary is generated based on a second portion of the transcript at the second state.

The processor may be further configured to: determine a plurality of messages associated with the customer input data and the agent input data corresponding to the first state of the chat session; and update, for the first state of the chat session and by the computer, a message buffer comprising a predetermined number of messages from among the plurality of messages corresponding to the first state of the chat session. When executing the large language model on the customer input data and the agent input data to generate the first summary, the processor may be configured to: execute the large language model on the customer input data and the agent input data corresponding to the predetermined number of messages in the message buffer to generate the first summary.

The processor may be further configured to: determine a plurality of messages associated with the customer input data and the agent input data corresponding to the first state of the chat session and the second state of the chat session; and update a message buffer comprising a predetermined number of messages from among the plurality of messages corresponding to the first state of the chat session or the second state of the chat session. When executing the large language model on the customer input data and the agent input data to generate the second summary the processor may be configured to: execute the large language model on the customer input data and the agent input data corresponding to the predetermined number of messages in the message buffer to generate the second summary.

When executing the large language model on the customer input data and the agent input data at the first state to generate the first summary the processor may be configured to: generate one or more outputs associated with the first summary by executing the large language model on a prompt response, the customer input data, and the agent input data to the large language model; and obtain the one or more outputs from the large language model, the one or more outputs are associated with the first summary, wherein the prompt response includes input text indicating one or more conditions for the large language model to process the customer input data and the agent input data based on one or more conditions.

When updating the agent chat interface of the agent device based on the first summary, the processor may be configured to: generate a graphical user interface (GUI) based on the first summary; generate GUI data associated with the GUI based on generating the GUI, the GUI data configured to cause display device to present the GUI. When updating the agent chat interface of the agent device based on the second summary the processor may be configured to: generate a second graphical user interface (GUI) based on the second summary; generate second GUI data associated with the second GUI based on generating the second GUI, the second GUI data configured to cause display device to display the GUI.

In an embodiment, a non-transitory machine-readable storage medium has instructions stored thereon that, when executed by one or more processors, cause the one or more processors to: receiving customer input data from a client device and agent input data from an agent device during a chat session; for a first state of the chat session, execute a large language model on the customer input data and the agent input data at the first state to generate a first summary; and update an agent chat interface of the agent device based on the first summary; and for a second state of the chat session, execute the large language model on the customer input data and the agent input data at the second state to generate a second summary; and update the agent chat interface based on the second summary.

The instructions that cause the one or more processors to execute the large language model on the customer input data and the agent input data at the second state to generate a second summary may cause the one or more processors to: execute the large language model on the first summary, the customer input data, and the agent input data at the second state to generate the second summary.

The instructions may further cause the one or more processors to: determine that a transition has occurred between the first state of the chat session and the second state of the chat session, the transition associated with an indication that the agent chat interface was updated based on an intervening chat session, wherein, when executing the large language model during the second state of the chat session, the large language model is executed based on determining that the transition has occurred between the first state of the chat session and the second state of the chat session.

The instructions may further cause the one or more processors to: determine that a transition has occurred between the first state of the chat session and the second state of the chat session, the transition associated with an indication that an amount of time has passed since the agent chat interface was updated during the first state of the chat session, the amount of time satisfying a threshold amount of time. The instructions that cause the one or more processors to execute the large language model during the second state of the chat session may cause the one or more processors to execute the large language model based on determining that the transition has occurred between the first state of the chat session and the second state of the chat session.

The customer input data corresponding to the first state may be associated with a first message. The instructions may further cause the one or more processors to: determine, during the second state, that the customer input data corresponding to the second state is associated with a second message. The instructions that cause the one or more processors to execute the large language model during the second state of the chat session may cause the one or more processors to execute the large language model based on receiving the customer input data that is associated with the second message.

The instructions may further cause the one or more processors to: obtain a first feature embedding from the first summary; and select a form file from a plurality of form files stored in a database based on an embedding search using the first feature embedding against the database. The instructions that cause the one or more processors to update the agent chat interface may cause the one or more processors to: update the agent chat interface of the agent device based on the form file selected using the first summary.

The instructions that cause the one or more processors to update the agent chat interface of the agent device based on the form file selected using the first summary may cause the one or more processors to: generate graphical user interface (GUI) data associated with a GUI based on the form file selected using the first summary, the GUI representing at least a portion of the form file selected using the first summary.

The instructions may further cause the one or more processors to: at the second state: obtain a second feature embedding from the second summary; select a second form file from the plurality of form files stored in the database based on a second embedding similarity between the second feature embedding and a further feature embedding of the form file, the second embedding similarity satisfying a match threshold; and update the agent chat interface of the agent device based on the second form file selected using the second summary.

The instructions that cause the one or more processors to update the agent chat interface of the agent device based on the second form file selected using the second summary may cause the one or more processors to: update the GUI based on the second form file from the plurality of form files stored in the database, the GUI representing at least a portion of the second form file selected using the second summary; generate second GUI data associated with the GUI based on updating the GUI.

The instructions may further cause the one or more processors to: parse a form file into a plurality of fields, each field comprising a field name; and identify an instance of the field name of at least one field in at least one of the first summary or the second summary.

The instructions that cause the one or more processors to receive the customer input data from the client device may cause the one or more processors to: receive customer input data from a plurality of client devices that are associated with distinct customers, the plurality of client devices corresponding to a plurality of chat sessions that are simultaneously performed, and update the agent chat interface for the agent device based on the plurality of chat sessions.

The instructions may further cause the one or more processors to: generate, during the chat session, a transcript of the chat session based on the customer input data and the agent input data, wherein the first summary is generated based on a first portion of the transcript at the first state, and wherein the second summary is generated based on a second portion of the transcript at the second state.

The instructions may further cause the one or more processors to: determine a plurality of messages associated with the customer input data and the agent input data corresponding to the first state of the chat session; and update, for the first state of the chat session and by the computer, a message buffer comprising a predetermined number of messages from among the plurality of messages corresponding to the first state of the chat session. The instructions that cause the one or more processors to execute the large language model on the customer input data and the agent input data to generate the first summary may cause the one or more processors to: execute the large language model on the customer input data and the agent input data corresponding to the predetermined number of messages in the message buffer to generate the first summary.

The instructions may further cause the one or more instructions to determine a plurality of messages associated with the customer input data and the agent input data corresponding to the first state of the chat session and the second state of the chat session; and updating a message buffer comprising a predetermined number of messages from among the plurality of messages corresponding to the first state of the chat session or the second state of the chat session. The instructions that cause the one or more processors to execute the large language model on the customer input data and the agent input data to generate the second summary may cause the one or more processors to: execute the large language model on the customer input data and the agent input data corresponding to the predetermined number of messages in the message buffer to generate the second summary.

The instructions that cause the one or more processors to execute the large language model on the customer input data and the agent input data at the first state to generate the first summary may cause the one or more processors to: generate one or more outputs associated with the first summary by executing the large language model on a prompt response, the customer input data, and the agent input data; and obtain the one or more outputs from the large language model, the one or more outputs associated with the first summary, wherein the prompt response includes input text indicating one or more conditions for the large language model to process the customer input data and the agent input data based on the one or more conditions.

Some non-limiting embodiments of the present disclosure are described herein in connection with a threshold. As described herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, and/or the like.

The foregoing method descriptions and the process flow diagrams are provided merely as illustrative examples and are not intended to require or imply that the operations of the various embodiments must be performed in the order presented. The operations in the foregoing embodiments may be performed in any order. Words such as “then,” “next,” etc., are not intended to limit the order of the operations; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, and the like. When a process corresponds to a function, the process termination may correspond to a return of the function to a calling function or a main function.

As used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open ended terms. Further, the phrase “based on” is intended to mean “based at least partially on” unless explicitly stated otherwise.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure or the claims.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The operations of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the embodiments described herein and variations thereof. Various modifications to these embodiments will be readily apparent to those skilled in the art, and the generic principles defined herein may be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A computer-implemented method comprising:
receiving, by a computer, customer input data from a client device and agent input data from an agent device during a chat session;
for a first state of the chat session,
executing, by the computer, a large language model on the customer input data and the agent input data at the first state to generate a first summary; and
updating, by the computer, an agent chat interface of the agent device based on the first summary; and
for a second state of the chat session,
executing, by the computer, the large language model on the customer input data and the agent input data at the second state to generate a second summary; and
updating, by the computer, the agent chat interface based on the second summary.

2. The computer-implemented method of claim 1, wherein executing the large language model on the customer input data and the agent input data at the second state to generate a second summary comprises:
executing, by the computer, the large language model on the first summary, the customer input data, and the agent input data at the second state to generate the second summary.

3. The computer-implemented method of claim 1, further comprising:
determining, by the computer, that a transition has occurred between the first state of the chat session and the second state of the chat session, the transition associated with an indication that the agent chat interface was updated based on an intervening chat session,
wherein, when executing the large language model during the second state of the chat session, the large language model is executed based on determining that the transition has occurred between the first state of the chat session and the second state of the chat session.

4. The computer-implemented method of claim 1, further comprising:
determining, by the computer, that a transition has occurred between the first state of the chat session and the second state of the chat session, the transition associated with an indication that an amount of time has passed since the agent chat interface was updated during the first state of the chat session, the amount of time satisfying a threshold amount of time,
wherein, when executing the large language model during the second state of the chat session, the large language model is executed based on determining that the transition has occurred between the first state of the chat session and the second state of the chat session.

5. The computer-implemented method of claim 1, wherein the customer input data corresponding to the first state is associated with a first message, the computer-implemented method further comprising:
determining, by the computer and during the second state, that the customer input data corresponding to the second state is associated with a second message,
wherein, when executing the large language model during the second state of the chat session, the large language model is executed based on receiving the customer input data that is associated with the second message.

6. The computer-implemented method according to claim 1, further comprising:
obtaining, by the computer, a first feature embedding from the first summary; and
selecting, by the computer, a form file from a plurality of form files stored in a database based on an embedding search using the first feature embedding against the database,
wherein the computer updates the agent chat interface based on the form file selected using the first summary.

7. The computer-implemented method according to claim 6, wherein updating the agent chat interface of the agent device based on the form file selected using the first summary comprises:
generating, by the computer, graphical user interface (GUI) data associated with a GUI based on the form file selected using the first summary, the GUI representing at least a portion of the form file selected using the first summary.

8. The computer-implemented method according to claim 6, further comprising, at the second state:
obtaining, by the computer, a second feature embedding from the second summary;
selecting, by the computer, a second form file from the plurality of form files stored in the database based on a second embedding similarity between the second feature embedding and a further feature embedding of the form file, the second embedding similarity satisfying a match threshold; and
updating, by the computer, the agent chat interface of the agent device based on the second form file selected using the second summary.

9. The computer-implemented method according to claim 8, wherein, updating the agent chat interface of the agent device based on the second form file selected using the second summary comprises:
updating, by the computer, the GUI based on the second form file from the plurality of form files stored in the database, the GUI representing at least a portion of the second form file selected using the second summary; and
generating, by the computer, second GUI data associated with the GUI based on updating the GUI.

10. The computer-implemented method according to claim 1, further comprising:
parsing, by the computer, a form file into a plurality of fields, each field comprising a field name; and
identifying, by the computer, an instance of the field name of at least one field in at least one of the first summary or the second summary.

11. The computer-implemented method according to claim 1, wherein receiving the customer input data from the client device comprises:
receiving, by the computer, customer input data from a plurality of client devices that are associated with distinct customers, the plurality of client devices corresponding to a plurality of chat sessions that are simultaneously performed, and
updating, by the computer, the agent chat interface for the agent device based on the plurality of chat sessions.

12. The computer-implemented method according to claim 1, further comprising:
generating, by the computer during the chat session, a transcript of the chat session based on the customer input data and the agent input data,
wherein the first summary is generated based on a first portion of the transcript at the first state, and wherein the second summary is generated based on a second portion of the transcript at the second state.

13. The computer-implemented method of claim 1, further comprising:
determining, by the computer, a plurality of messages associated with the customer input data and the agent input data corresponding to the first state of the chat session; and
updating, for the first state of the chat session and by the computer, a message buffer comprising a predetermined number of messages from among the plurality of messages corresponding to the first state of the chat session;
wherein the computer applies the large language model on the customer input data and the agent input data corresponding to the predetermined number of messages in the message buffer to generate the first summary.

14. The computer-implemented method of claim 13, further comprising:
determining, by the computer, a plurality of messages associated with the customer input data and the agent input data corresponding to the first state of the chat session and the second state of the chat session; and
updating, by the computer, a message buffer comprising a predetermined number of messages from among the plurality of messages corresponding to the first state of the chat session or the second state of the chat session;
wherein the computer applies the large language model on the customer input data and the agent input data corresponding to the predetermined number of messages in the message buffer to generate the second summary.

15. The computer-implemented method of claim 1, wherein executing the large language model on the customer input data and the agent input data at the first state to generate the first summary comprises:
generating, by the computer, one or more outputs associated with the first summary by executing the large language model on a prompt response, the customer input data, and the agent input data; and
obtaining, by the computer, the one or more outputs from the large language model, the output associated with the first summary,
wherein the prompt response includes input text indicating one or more conditions for the large language model to process the customer input data and the agent input data based on the one or more conditions.

16. A computer system comprising:
a server comprising a processor configured to:
receive customer input data from a client device and agent input data from an agent device during a chat session;
for a first state of the chat session,
execute a large language model on the customer input data and the agent input data at the first state to generate a first summary; and
update an agent chat interface of the agent device based on the first summary; and
for a second state of the chat session,
execute the large language model on the customer input data, and the agent input data at the second state to generate a second summary; and
update the agent chat interface based on the second summary.

17. The computer system of claim 16, wherein the processor is further configured to:
determine that a transition has occurred between the first state of the chat session and the second state of the chat session, the transition associated with an indication that the agent chat interface was updated based on an intervening chat session,
wherein, when executing the large language model during the second state of the chat session, the large language model is executed based on determining that the transition has occurred between the first state of the chat session and the second state of the chat session.

18. The computer system of claim 16, wherein the processor is further configured to:
determine that a transition has occurred between the first state of the chat session and the second state of the chat session, the transition associated with an indication that an amount of time has passed since the agent chat interface was updated during the first state of the chat session, the amount of time satisfying a threshold amount of time,
wherein, when executing the large language model during the second state of the chat session, the large language model is executed based on determining that the transition has occurred between the first state of the chat session and the second state of the chat session.

19. The system according to claim 16, wherein, when the customer input data corresponding to the first state is associated with a first message, the processor is further configured to:
determine, during the second state, that the customer input data corresponding to the second state is associated with a second message, and
wherein, when executing the large language model during the second state of the chat session, the processor is configured to execute the large language model based on receiving the customer input data that is associated with the second message.

20. A non-transitory machine-readable storage medium has instructions stored thereon that, when executed by one or more processors, cause the one or more processors to:
receive customer input data from a client device and agent input data from an agent device during a chat session;
for a first state of the chat session,
execute a large language model on the customer input data and the agent input data at the first state to generate a first summary; and
update an agent chat interface of the agent device based on the first summary; and
for a second state of the chat session,
execute the large language model on the customer input data, and the agent input data at the second state to generate a second summary; and
update the agent chat interface based on the second summary.
